(19) United States
(12) Patent Application Publication
(10) Pub. No.: US 2025/0308058 A1
(43) Pub. Date: Oct. 2, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: YUKI KANAI, Kanagawa (JP)

(21) Appl. No.: 19/090,195

(22) Filed: Mar. 25, 2025

(30) Foreign Application Priority Data
Mar. 27, 2024 (JP) 2024-051852

(51) Int. Cl. G06T 7/70; G06T 5/50; G06T 7/20; G06T 7/62; G06V 10/25; G06V 20/54

(52) U.S. Cl. CPC G06T 7/70; G06T 5/50; G06T 7/20; G06T 7/62; G06V 10/25; G06V 20/54; G06T 2207/20221; G06V 2201/07

(57) ABSTRACT

An information processing apparatus includes at least one memory storing instructions and at least one processor. Upon execution of the stored instructions, the at least one processor causes the information processing apparatus to detect an object in a captured image, track the object in a chronologically captured image, based on a result of the detection of the object, estimate, from the captured image, a region in which detection of the object in the captured image is difficult for the detection unit per type of the object, based on the result of the detection of the object and a result of the tracking of the object, and generate an image acquired by superimposing, on a predetermined background image, a predetermined object image that corresponds to the type of the object, based on a result of the estimation.

### BACKGROUND

### Technical Field

The present disclosure relates to an information processing technique for generating an image.

### Description of the Related Art

An existing system for traffic monitoring captures an object that moves on a road such as a vehicle or a person by using a network camera, analyzes the captured image, and detects the type and position of the object that appears in the image. A detection device that detects the type and position of the object in the image by analyzing the image is preferably optimized for environments at the location of capturing to acquire a highly precise traffic monitoring system.

In a method of detecting an object in a captured image disclosed in J.Redmon, A.Farhadi, “YOLO9000: Better Faster Stronger”, Computer Vision and Pattern Recognition (CVPR) 2016, the types and coordinates of objects in images are learned by a network model in advance by using a deep learning technique, and the type and coordinates of an object in an unknown image can be detected. Images of difficult scenes where missed object detection or false object detection is likely to occur can be collected and learned by the network model to acquire the detection device that is optimized for the environments of the location by using the method. It is necessary to collect the multiple images of the difficult scenes and to provide information about the types and the coordinates to the objects that appear in the images in order to generate learning data for the network model, which needs a large amount of manual work effort.

A technique disclosed in Japanese Patent Laid-Open No. 2021-76992 is to use a simulation system in which a Computer Graphics (CG) image is used and to consequently facilitate generation of learning data of various images in which detection is difficult for a detection device. The use of the technique disclosed in Japanese Patent Laid-Open No. 2021-76992 enables the learning data based on the images of difficult scenes for the detection device to be easily generated.

A technique disclosed in Japanese Patent Laid-Open No. 2022-169068 is to detect a difficult region in which a detection device that uses a neural network model can perform false detection or missed detection and to estimate information about the difficult region. The estimation of a region that can be a difficult scene for the detection device by using the technique disclosed in Japanese Patent Laid-Open No. 2022-169068 can be used to generate effective learning data.

Even when the techniques disclosed in Japanese Patent Laid-Open No. 2021-76992 and Japanese Patent Laid-Open No. 2022-169068 are used, it is difficult to generate an image that is used for the learning data in order to acquire a detection device that detects various objects that can be present at various positions in the actual environments without missed detection or false detection.

### SUMMARY

The present disclosure enables an image in which detection of an object is difficult for a device that detects the object in the image to be easily generated.

The present disclosure provides an information processing apparatus including at least one memory storing instructions; and at least one processor that, upon execution of the stored instructions, causes the information processing apparatus to detect an object in a captured image; track the object in a chronologically captured image, based on a result of the detection of the object; estimate, from the captured image, a region in which detection of the object in the captured image is difficult for the detection unit per type of the object, based on the result of the detection of the object and a result of the tracking of the object; and generate an image acquired by superimposing, on a predetermined background image, a predetermined object image that corresponds to the type of the object, based on a result of the estimation.

Further features of the present disclosure will become apparent from the following description of exemplary embodiments with reference to the attached drawings.

### BRIEF DESCRIPTION OF THE DRAWINGS

FIG. 1 illustrates an example of a system configuration.

FIG. 2 illustrates an example of a schematic inner structure of an image capturing device.

FIG. 3 illustrates an example of a functional configuration of the image capturing device.

FIG. 4 illustrates an example of a hardware configuration of a server.

FIG. 5 illustrates an example of a functional configuration of the server.

FIG. 6 illustrates an example of a precision region image.

FIG. 7 illustrates an example of a precision region image that contains a region in which no object is present.

FIG. 8 illustrates an example of an object presence region setting screen.

FIG. 9 illustrates an example of object presence region information.

FIG. 10 is a flowchart illustrating the flow of information processing according to the present embodiment.

FIG. 11 illustrates an example of object detection result information.

FIG. 12 illustrates an example of object tracking result information.

FIG. 13 is a flowchart of a precision region estimation process according to a first embodiment.

FIG. 14A and FIG. 14B are diagrams illustrating the precision region estimation process.

FIG. 15 illustrates an example of precision region information according to the first embodiment.

FIG. 16 is a flowchart of an image generation process according to the first embodiment.

FIG. 17A to FIG. 17F illustrate an example of input data and output data for the image generation process.

FIG. 18A and FIG. 18B illustrate an example of a precision region check screen and a precision region setting screen.

FIG. 19 is a flowchart illustrating a precision region estimation process according to a second embodiment.

FIG. 20 is a flowchart illustrating a precision region estimation process according to a third embodiment.

FIG. 21 illustrates an example of precision region information according to the third embodiment.

FIG. 22 is a flowchart illustrating the flow of information processing according to a fourth embodiment.

FIG. 23 illustrates an example of a prompt that is used for precision region estimation according to the fourth embodiment.

FIG. 24 is a flowchart illustrating a precision region estimation process according to a fifth embodiment.

FIG. 25 is a flowchart illustrating a detailed parameter estimation process.

FIG. 26 illustrates an example of detailed parameter information.

FIG. 27 is a flowchart illustrating an image generation process according to the fifth embodiment.

FIG. 28A and FIG. 28B illustrate examples of prompts that are used for image generation according to the fifth embodiment.

### DESCRIPTION OF THE EMBODIMENTS

Embodiments of the present disclosure will hereinafter be described with reference to the drawings. The described embodiments do not limit the present disclosure, and not all combinations of features described according to the embodiments are essential to solutions according to the present disclosure. Structures according to the embodiments can be appropriately modified or changed depending on various conditions (such as for use and usage environments) and specifications of devices to which the present disclosure is used. According to the below described embodiments, identical or like components or processing processes are designated by identical reference characters, and a duplicated description is omitted.

### First Embodiment

### System Configuration

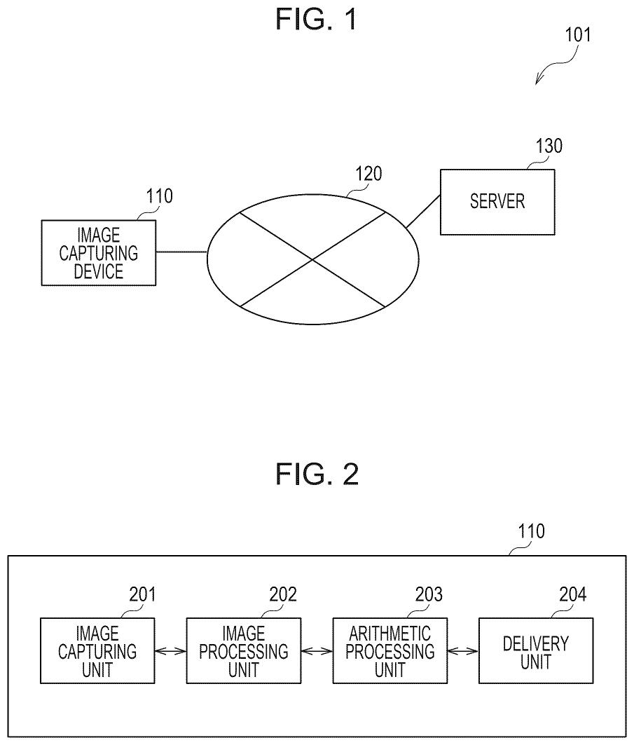

FIG. 1 illustrates an example of the structure of an image analysis system 101 according to the present embodiment. An example in which the image analysis system 101 is used for a traffic monitoring system will now be described. However, the image analysis system 101 according to the present embodiment is not limited to a traffic management system, and may be used for a system that analyzes an image and that outputs predetermined information. The image analysis system 101 illustrated in FIG. 1 by way of example includes an image capturing device 110, a network 120, and a server 130.

An example of the image capturing device 110 is a network camera. In an example according to the present embodiment, the image capturing device 110 includes an arithmetic unit that is capable of processing an image but is not limited thereto. For example, an external information processing apparatus such as a personal computer (PC) that is connected to an image capturing device may process an image, and a combination of the image capturing device and the external information processing apparatus may be used as the image capturing device 110. The server 130 is an information processing apparatus such as a PC and has a function of information processing including an image analysis process according to the present embodiment. The server 130 is capable of receiving an input from a user and is capable of outputting information (for example, displaying information) to the user.

The image capturing device 110 and the server 130 are connected to each other so as to be capable of communicating via the network 120. For example, the network 120 includes multiple routers, switches, and cables that satisfy a communication standard, such as the Ethernet® standard. According to the present embodiment, the network 120 may be a network that enables communication between the image capturing device 110 and the server 130 and may be established in accordance with a scale or structure or a conforming communication standard. For example, the network 120 may be the internet, a wired local area network (LAN), a wireless LAN, or a wide area network (WAN). For example, the network 120 may enable communication by using a communication protocol conforming to an open network video interface forum (ONVIF) standard. These are examples, and the network 120 may enable communication by using another communication protocol, such as an original communication protocol.

### Structure of Image Capturing Device

The structure of the image capturing device 110 will now be described. FIG. 2 illustrates a schematic structure of the image capturing device 110. For example, the image capturing device 110 includes an image capturing unit 201, an image processing unit 202, an arithmetic processing unit 203, and a delivery unit 204. Components illustrated in FIG. 2 include hardware such as respective circuits.

The image capturing unit 201 includes an image capturing element that captures an imaged optical image and that outputs an analog signal, a lens system for imaging the optical image of, for example, an object for the image capturing element, and an optical drive unit. The lens system includes a zoom lens that changes the angle of view, a focus lens for focusing, and an aperture that adjusts the amount of light. The optical drive unit drives the zoom lens, the focus lens, and the aperture. The image capturing element has a gain function of adjusting a sensitivity when the light is converted into the analog signal. These functions are adjusted based on setting values that are reported from the image processing unit 202. The analog signal that is acquired by the image capturing unit 201 is converted into a digital signal by using an analog-digital conversion circuit (not illustrated) and is transmitted as an image signal to the image processing unit 202.

For example, the image processing unit 202 may include an image processing engine and a peripheral device. For example, the peripheral device may include a random access memory (RAM) and a driver of an interface (I/F). The image processing unit 202 performs predetermined image processes, such as a development process, a filtering process, sensor correction, and noise removal, on the image signal that is acquired from the image capturing unit 201 and generates image data. The image processing unit 202 transmits a setting value to the optical drive unit and the image capturing element, adjusts the angle of view, and adjusts exposure such that an appropriate exposure image can be acquired at the desired angle of view. The image data that is generated by the image processing unit 202 is transferred to the arithmetic processing unit 203.

The arithmetic processing unit 203 includes one or more processors, such as CPUs or MPUs, a memory such as a RAM or a ROM, and a driver of an I/F. CPU is an acronym for a central processing unit. MPU is an acronym for a micro processing unit. RAM is an acronym for a random access memory. ROM is an acronym for a read only memory.

The delivery unit 204 includes a network delivery engine and a peripheral device, such as a RAM or an ETH PHY module. The ETH PHY module performs a process of a physical (PHY) layer of the Ethernet. The delivery unit 204 converts the data of the result of processing and the image data acquired from the arithmetic processing unit 203 into a deliverable form for the network 120 and outputs the converted data to the network 120.

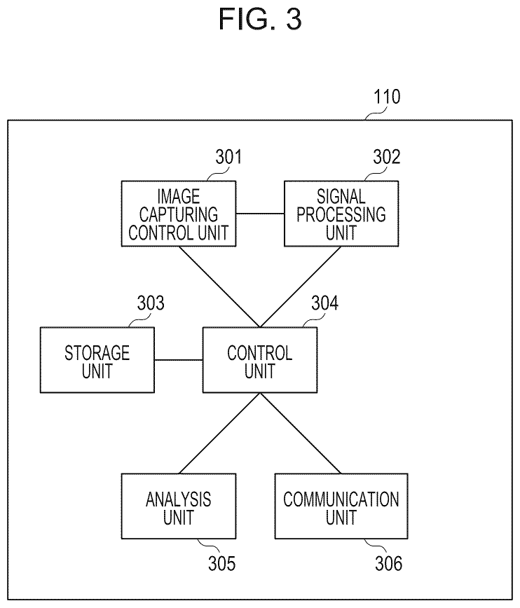

FIG. 3 illustrates an example of a functional configuration of the image capturing device 110. The image capturing device 110 includes an image capturing control unit 301, a signal processing unit 302, a storage unit 303, a control unit 304, an analysis unit 305, and a communication unit 306.

The image capturing control unit 301 includes the image capturing unit 201 described above, controls a capturing operation of the image capturing unit 201, and transmits an image capturing signal that has been acquired by the image capturing unit 201 to the signal processing unit 302.

The signal processing unit 302 includes the image processing unit 202 and the arithmetic processing unit 203 described above and generates captured image data by performing a predetermined process on the image capturing signal that is transmitted from the image capturing control unit 301. In addition, for example, the captured image data may be encoded. The captured image data is referred to below as the captured image or is simply referred to the image. In the case where the captured image is a still image, the signal processing unit 302 encodes the still image by using an encoding method such as joint photographic experts group (JPEG). In the case where the captured image is a moving image, the signal processing unit 302 encodes the moving image by using an encoding method such as H.264/MPEG-4 AVC or high efficiency video coding (HEVC). Also the use of an encoding method that the user selects among multiple encoding methods that are set in advance by using, for example, an operation unit of the image capturing device 110 (not illustrated) enables encoding of the signal processing unit 302.

The storage unit 303 stores temporary data when various processes are performed.

The control unit 304 controls the signal processing unit 302, the storage unit 303, the analysis unit 305, and the communication unit 306 such that these perform respective predetermined processes.

The analysis unit 305 performs various image analysis processes on the captured image.

The communication unit 306 includes the delivery unit 204 described above and communicates with the server 130 via the network 120.

### Structure of Server

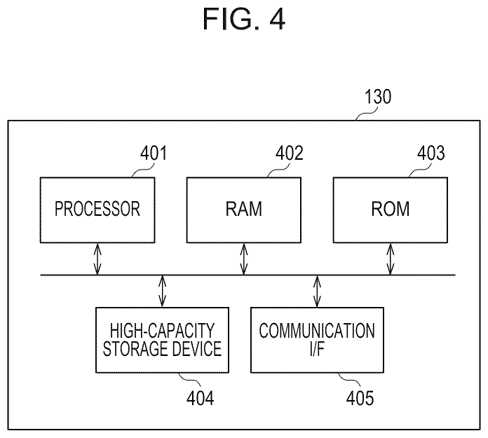

FIG. 4 illustrates an example of a hardware configuration of the server 130. The server 130 includes an information processing apparatus, such as a typical PC. That is, as illustrated in FIG. 4, the server 130 includes, for example, a processor 401 such as a CPU, memories such as a RAM 402 and a ROM 403, a high-capacity storage device 404 such as an HDD or an SSD, and a communication I/F 405.

As for the server 130, the processor 401 runs various programs including an information processing program according to the present embodiment that are stored in the ROM 403 or the high-capacity storage device 404, and consequently, various functions can be performed. The RAM 402 is used as, for example, a temporary storage region when the processor 401 performs various processes. The communication I/F 405 is connected to the network 120 and communicates with an external device such as the image capturing device 110.

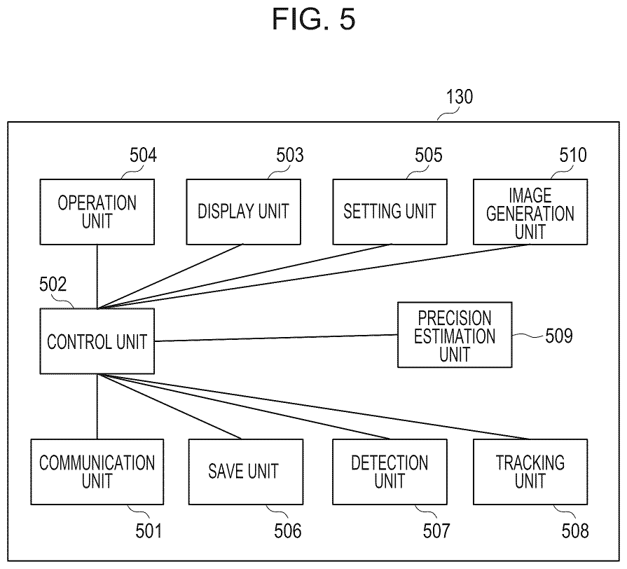

FIG. 5 illustrates an example of a functional configuration of the server 130 according to the present embodiment. For example, the server 130 includes, as the functional configuration, a communication unit 501, a control unit 502, a display unit 503, an operation unit 504, a setting unit 505, a save unit 506, a detection unit 507, a tracking unit 508, a precision estimation unit 509, and an image generation unit 510.

The communication unit 501 includes the communication I/F 405 described above and communicates with an external device, such as the image capturing device 110, via, for example, the network 120. This is just an example, and, for example, the communication unit 501 is capable of establishing a connection directly with the image capturing device 110 without the network 120 or another device and is capable of communicating with the image capturing device 110.

The display unit 503 provides various kinds of information to the user, for example, via a screen display of a built-in or external display device. According to the present embodiment, the display unit 503 has the function of a browser, displays the rendering result of the browser on the screen of the display device, and, consequently, provides various kinds of information to the user. The detail of the information that is provided to the user via the screen display of the display device will be described later.

The operation unit 504 receives an operation from the user. According to the present embodiment, examples of the operation unit 504 include a mouse and a keyboard, the user operates these, and a user operation is inputted via the browser described above. The operation unit 504 is not limited thereto but may be a device that is capable of acquiring an instruction from the user, such as a touch screen or a microphone.

The control unit 502 controls the communication unit 501, the display unit 503, the operation unit 504, the setting unit 505, the save unit 506, the detection unit 507, the tracking unit 508, the precision estimation unit 509, and the image generation unit 510 such that these perform respective processes described later.

For example, the setting unit 505 performs a setting process described later.

The detection unit 507 functions as an object detector that detects an object (referred to below as a target detection object) to be detected appearing in the captured image that is transmitted from the image capturing device 110. For example, the detection unit 507 performs an object detection process by using the object detector that includes an object detection model that was learned by using machine learning to which a deep learning technique was applied. The detection unit 507 detects the target detection object in the captured image and then acquires at least an object class that represents the type of the object per detected object and vertex coordinates of a circumscribed rectangle (a rectangle called a bounding box) per object, although the details will be described later. The detection unit 507 transmits the result of object detection in the object detection process to the control unit 502. The control unit 502 saves, as object detection result information, the result of object detection performed by the detection unit 507 in the save unit 506.

The tracking unit 508 performs an object tracking process such that the object is tracked in captured images of chronologically continuous frames. The tracking unit 508 performs the tracking process based on a circumscribed rectangle (a bounding box) that is detected in the captured image of the current frame in the object detection process and a circumscribed rectangle (a bounding box) that is earlier detected and that is tracked in the object tracking process, although the details will be described later. The tracking unit 508 transmits the result of object tracking in the object tracking process to the control unit 502. The control unit 502 saves, as object tracking result information, the result of object tracking performed by the tracking unit 508 in the save unit 506.

According to the present embodiment, the circumscribed rectangle of the object that is detected in the object detection process of the detection unit 507 is referred to as the “detection rectangle”, and the circumscribed rectangle of the object that is tracked in the object tracking process of the tracking unit 508 is referred to as the “tracking rectangle”.

The precision estimation unit 509 estimates a region in which the detection of the object is difficult when the object detector of the detection unit 507 detects the object in the captured image, that is, a region in which false detection or missed detection is likely to occur per type (object class) of the target detection object. The precision estimation unit 509 determines that the result of estimation of the region in which the detection of the object is difficult is estimation accuracy per type (object class) of the target detection object. That is, the precision estimation unit 509 determines that a partial region that is estimated as a region in which the detection of the object in the captured image is difficult is a region that has high estimation accuracy and that a partial region that is estimated as a region in which the detection of the object is not difficult is a region that has low estimation accuracy per object class of the target detection object.

The precision estimation unit 509 performs a rendering process in which an image that represents the estimation accuracy per partial region that is estimated per type (object class) of the target detection object is generated. In the following description, the image that represents the estimation accuracy per partial region that is estimated per type of the target detection object is referred to as the precision region image. That is, the precision region image represents that the estimation accuracy of a region increases as the region is estimated such that the detection of the object is more difficult and that the estimation accuracy of a region decreases as the region is estimated such that the detection of the object is less difficult.

The image generation unit 510 receives, as input data, the precision region image that is generated by the precision estimation unit 509, a background image that is registered in advance, and a prompt described later; performs an image generation process; and generates a generation image and correct data described later. The image generation unit 510 according to the present embodiment generates, as the generation image, an image acquired in a manner in which a predetermined object image that depends on the estimation accuracy of the partial region per type of the target detection object in the precision region image is superimposed on the background image. The image generation unit 510 disposes the predetermined object image preferentially in a region that has high estimation accuracy that is acquired by the precision estimation unit 509 when the generation image is generated.

According to the present embodiment, the image generation unit 510 performs the image generation process by using an image generator of an image generation model that was trained by machine learning where a lurking pattern is found from a large amount of data by repeatedly making calculations. For this reason, according to the present embodiment, a predetermined image that depends on the estimation accuracy of the partial region per type of the target detection object means an image of an object that the object detector detects in the region in which the detection of the object is difficult and that is used for the machine learning.

For example, a model to which the technique disclosed in a reference described below is applied can be used as the image generation model.

Reference: Alan D. Thompson, ‘Inside language models (from GPT-4 to Nova) https://lifearchitect.ai/models/(Feb. 25, 2025)

For example, the save unit 506 saves the object detection model of the object detector, object presence region information, the object detection result information, the object tracking result information, the precision region image per object class, the image generation model of the image generator, the background image, the generation image, and the correct data. The detail of the information that is held by the save unit 506 will be described later. The background image is captured by the image capturing device 110 in advance in environments in which no target detection object is present within the angle of view of the image capturing device 110.

For example, in the case where the image capturing device 110 photographs a certain road, the background image is an image in which no target detection object-such as a vehicle (e.g., a truck, a van, or a bike) or a person-appears, but only the road and a building around the road appear. This is not a limitation, and the target detection object may be removed by using, for example, an image editor tool from the image that is captured by the image capturing device 110, and an image that contains only the road and the building around the road may be generated and may be used as the background image.

### Precision Region Image

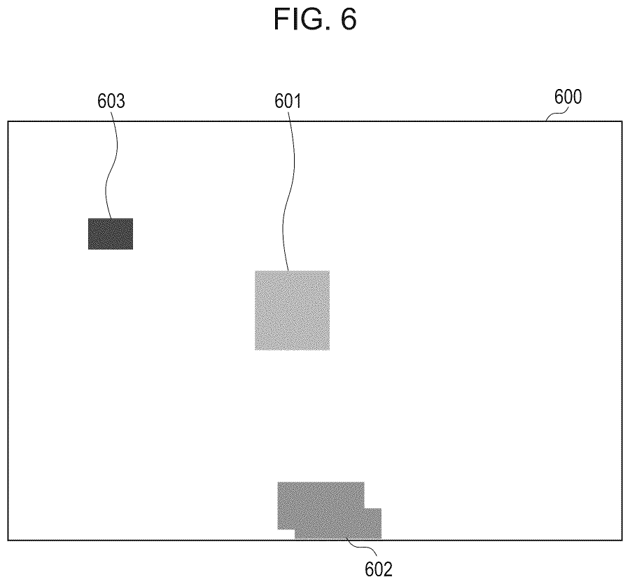

According to the present embodiment, the precision region image is rendered based on the estimation accuracy that is calculated in the precision region estimation process in which the region in which the detection of the object in the captured image is difficult is estimated and represents the estimation accuracy by using, for example, a difference in color. FIG. 6 illustrates an example of a precision region image 600 that is rendered based on the estimation accuracy that is the result of estimation of the region of an object class. In an example in FIG. 6, shades of gray represent the difference in color, and regions that are represented by high intensity of gray represent regions (that is, the estimation accuracy is high) in which the detection of the object is difficult, and a region that is represented in white represents a region (that is, the estimation accuracy is low) in which the detection of the object is not difficult. That is, in the case of the example in FIG. 6, regions 601, 602, and 603 are the regions in which the detection of the object is difficult. According to the present embodiment, as the intensity of gray becomes higher (as the estimation accuracy increases), the detection of the object is more difficult in the regions. In the case of the example in FIG. 6, the intensity of gray in the region 602 is higher than that in the region 601, and the intensity of gray in the region 603 is higher than that in the region 602. For this reason, it can be understood that the estimation accuracy in the region 602 is higher than that in the region 601, and the estimation accuracy in the region 603 is higher than that in the region 602, that is, the detection of the object is more difficult.

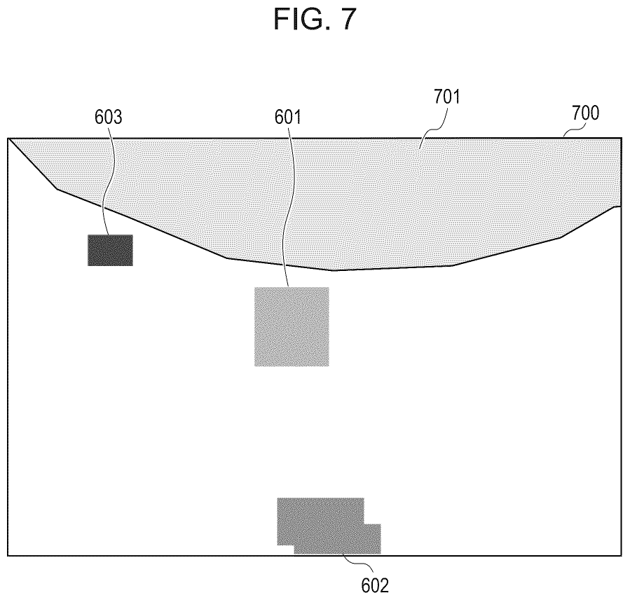

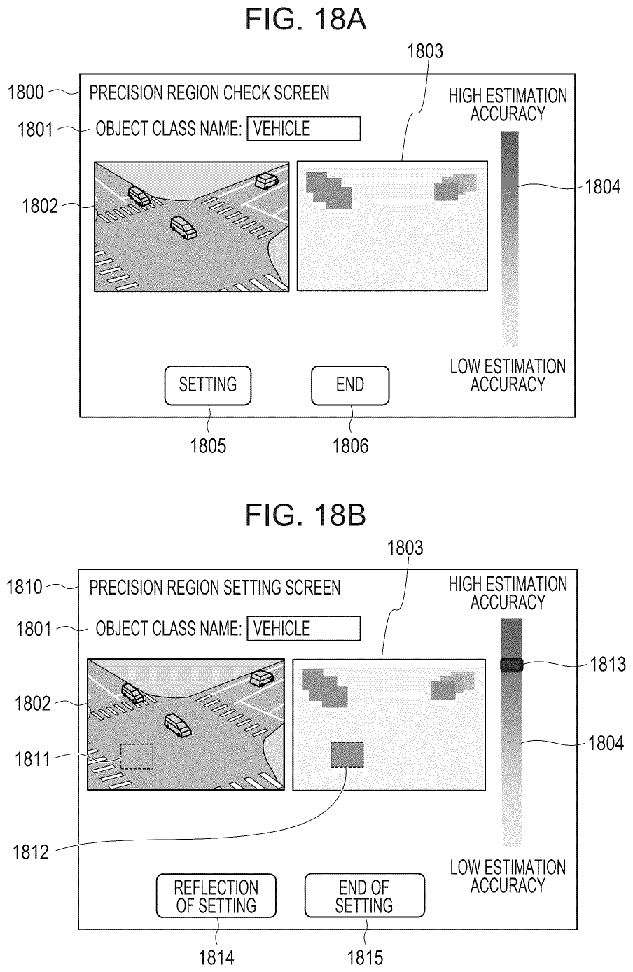

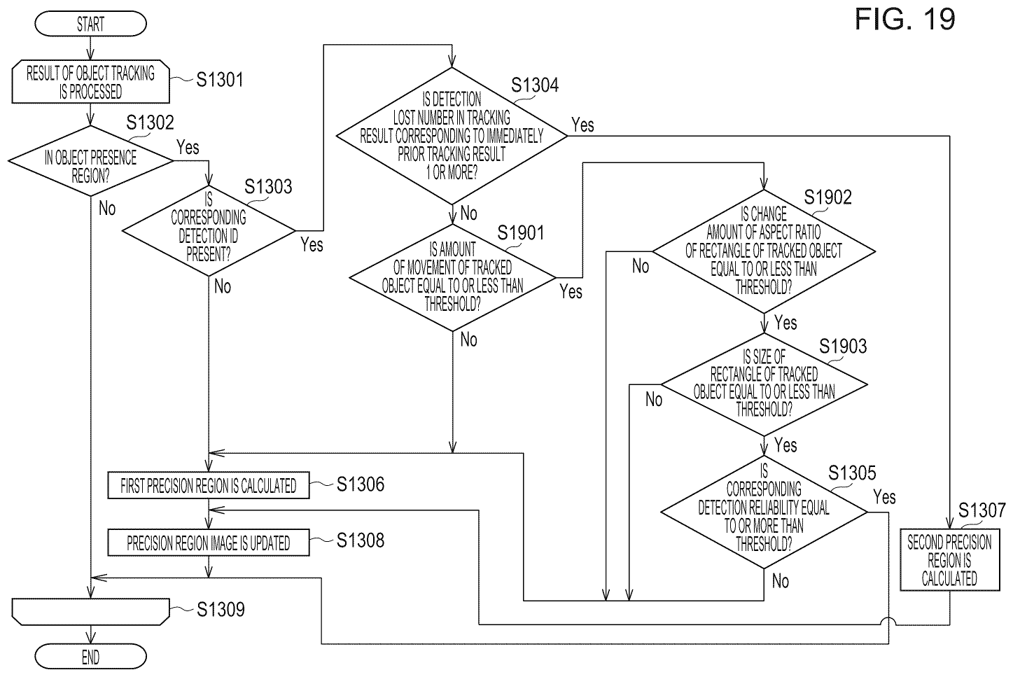

FIG. 7 illustrates an example of a precision region image 700 that differs from that in the example in FIG. 6. The precision region image 700 is acquired by superimposing a region that is not set as the object presence region in an object presence region setting process described later, that is, a region 701 in which no object is present on the precision region image 600 illustrated in FIG. 6. The precision region image 700 may be used on a precision region check screen that transitions from a precision region setting screen in FIG. 18A and FIG. 18B described later.

### Object Presence Region Setting Screen

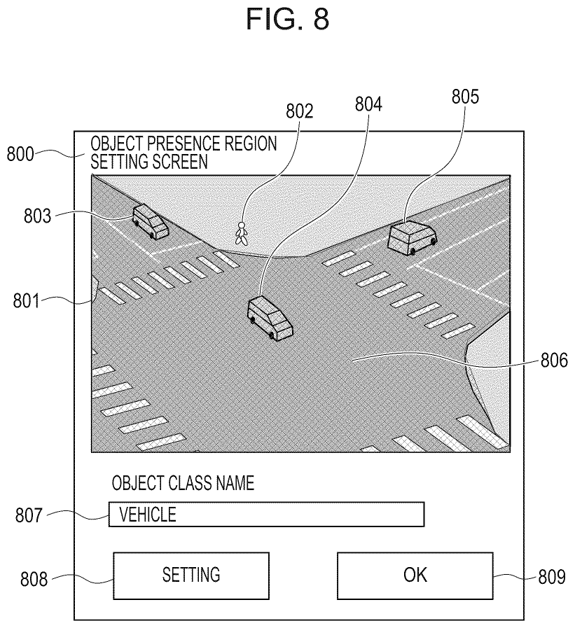

FIG. 8 illustrates an example of an object presence region setting screen that is generated and displayed by the setting unit 505 according to the present embodiment. The user of the server 130 can set the object presence region by using the object presence region setting screen illustrated in FIG. 8. An object presence region setting screen 800 includes a region in which the captured image is displayed, and the user can set the object presence region, a region in which the user inputs the object class name of the target detection object, and a region in which buttons that are operated by the user are displayed.

In an example in FIG. 8, an object class name input form 807 is a region into which the user inputs the object class name of the target detection object. A value that can be inputted into the object class name input form 807 needs to be suitable to the object class of the target detection object that is detectable by the detection unit 507. FIG. 8 illustrates an example in which a “vehicle” is inputted as the object class name into the object class name input form 807.

A captured image display region 801 is a region in which the captured image that is captured by the image capturing device 110 is displayed and the user can set the object presence region. The captured image that is displayed in the captured image display region 801 is acquired when the image capturing device 110 captures an intersection at which a person 802, a vehicle 803, a vehicle 804, and a vehicle 805 are present. According to the present embodiment, the user manually inputs and sets the object presence region while watching the captured image that is displayed in the captured image display region 801. According to the present embodiment, the user can manually input, as the object presence region, a polygonal-shaped region on the captured image in the captured image display region 801. The setting unit 505 acquires the vertex coordinates of the object presence region in a polygonal form that is manually inputted by the user and acquires, as region coordinate information, information about the coordinates of the object presence region that is represented by the vertex coordinates. Multiple object presence regions in a polygonal shape may be manually inputted by the user, and the object presence regions of the respective object classes may overlap. In the example in FIG. 8, a region that is represented in the captured image display region 801 by using grid lines is set as an object presence region 806 for the object class that is represented by the “vehicle” that is inputted into the object class name input form 807.

A setting button 808 and an OK button 809 can be pushed by mouse clicking or touching of the user.

When the user pushes the setting button 808 by mouse clicking or touching, the setting unit 505 sets, as the object presence region that corresponds to the object class that the user sets by using the object class name input form 807, the object presence region that the user sets in the captured image display region 801. The setting unit 505 transmits information about the object class and the information (the region coordinate information) about the coordinates of the object presence region that corresponds to the object class to the control unit 502. The control unit 502 saves, as the object presence region information, object class information about the target detection object and the region coordinate information in the save unit 506.

When the user pushes the OK button 809 by mouse clicking or touching, the control unit 502 causes the precision estimation unit 509 to perform the precision region estimation process and causes the image generation unit 510 to perform the image generation process as described later.

### Object Presence Region Information

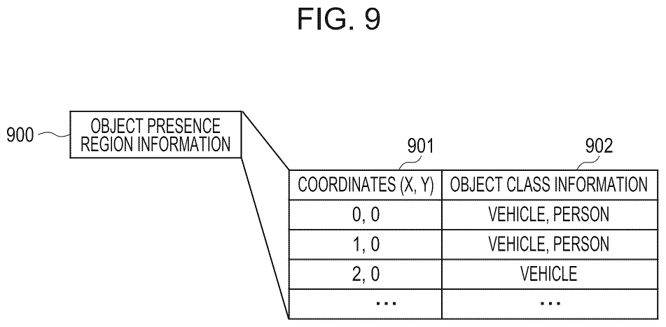

FIG. 9 illustrates an example of object presence region information 900 that is set on the object presence region setting screen and is saved in the save unit 506. The object presence region information 900 includes coordinates (X, Y) 901 and object class information 902.

The coordinates (X, Y) 901 are a set of X and Y coordinate values, and the X and Y coordinate values correspond to pixel coordinates of the captured image in the captured image display region 801. That is, when the captured image is an image of 1080×720 pixels, the coordinates (X, Y) 901 contain 1080×720 records.

The object class information 902 contains the object class name that is associated with the X and Y coordinates of the coordinates (X, Y) 901 and contains information that corresponds to the object class name that is inputted into the object class name input form 807 of the object presence region setting screen 800. That is, as for the object presence region information 900, the object class name in the object class information 902 is associated with the X and Y coordinates of the coordinates (X, Y) 901, and consequently, the object presence region per object class is represented. A region that is represented by X and Y coordinates for which no object class name is contained in the object class information 902 among the X and Y coordinates of the coordinates (X, Y) 901 is not set as the object presence region.

### Processing Flow

The flow of the information processing that is performed by the server 130 according to the present embodiment will now be described. Processing processes (processing steps) illustrated in flowcharts described later are performed in a manner in which the processor 401 of the server 130 runs the information processing program that is loaded on the RAM 402. However, this is just an example, and some or all of the processing processes in the flowcharts described later may be performed by not only the server 130 but also the image capturing device 110 or dedicated hardware. In the flowcharts described later, reference characters S represent the processing processes (the processing steps).

Information Processing according to First Embodiment

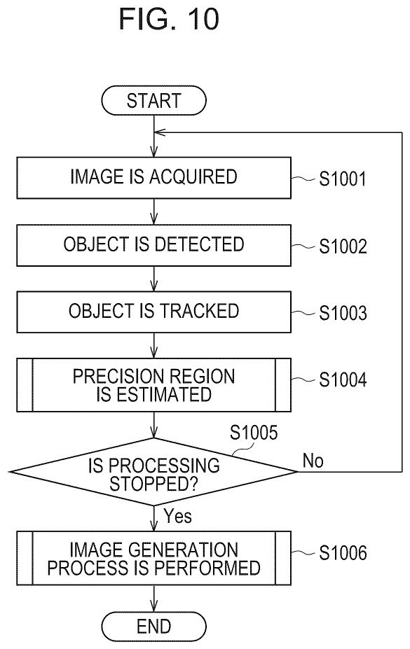

FIG. 10 is a flowchart illustrating the entire flow of the information processing that is performed by functional units of the server 130 illustrated in FIG. 5. For example, the processing in the flowchart starts in response to the OK button 809 that is pushed by the user on the object presence region setting screen 800.

At S1001, the control unit 502 first controls the communication unit 501 and acquires the captured image from the image capturing device 110. The captured image that is acquired at S1001 may be an image that was captured by the image capturing device 110 in advance and that is stored in the high-capacity storage device 404.

Subsequently, at S1002, the detection unit 507 performs the object detection process in which the target detection object that appears in the image is detected on the captured image that was acquired at S1001. The detection unit 507 detects the target detection object in the captured image, acquires the object class that represents the type of the detected object (referred to as the detection object) and the vertex coordinates (the vertex coordinates of the bounding box) of the detection rectangle per detection object, and transmits these to the control unit 502. The control unit 502 saves, as the object detection result information, information about the object class and the vertex coordinates of the detection rectangle that is acquired per detection object in the save unit 506.

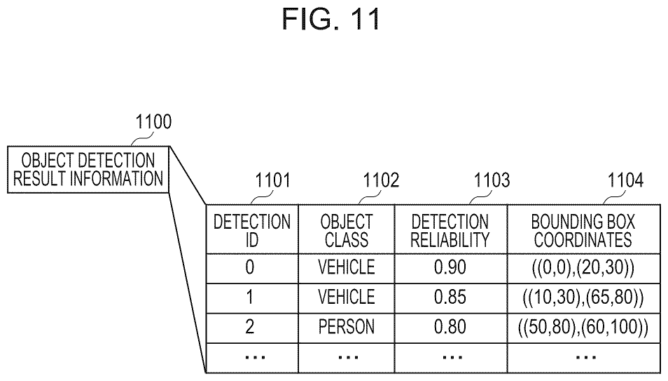

FIG. 11 illustrates an example of the object detection result information that is the result of the object detection process performed by the detection unit 507. Object detection result information 1100 includes information about a detection ID 1101, an object class 1102, detection reliability 1103, and bounding box coordinates 1104 corresponding per detection object.

The detection ID 1101 contains an identifier for identifying the detection object. The identifier that is contained in the detection ID 1101 is a random character string, such as letters or a numeral.

The object class 1102 contains the object class name of the detection object.

The detection reliability 1103 contains the value of detection reliability that represents the reliability of the result of object detection per detection object. For example, the value that represents the detection reliability is a numeral ranging from 0 to 1 and represents that as the numeral is closer to 1, the detection reliability increases.

The bounding box coordinates 1104 contain the vertex coordinates of the bounding box that is the detection rectangle per detection object. The values of the coordinates that are contained in the bounding box coordinates 1104 are the values of the coordinates of a coordinate system the origin of which is at the upper left coordinates of the captured image. The bounding box coordinates 1104 contain the X and Y coordinates of an upper left corner and the X and Y coordinates of a lower right corner of the detection rectangle (the bounding box) of the detection object.

Subsequently, at S1003, the tracking unit 508 performs the object tracking process by using the object detection result information that is detected in the image of the current frame and chronologically prior object detection result information in the object detection result information that is saved in the save unit 506, and the tracking unit 508 acquires the result of object tracking. The tracking unit 508 transmits the result of object tracking in the object tracking process to the control unit 502, and the control unit 502 saves, as the object tracking result information, the result of object tracking in the save unit 506.

In the object tracking process, the object detection result information that is acquired in the object detection process regarding the image of the current frame and the object tracking result information about the object that is acquired in the chronologically prior object tracking process are associated with each other. More specifically, the tracking unit 508 predicts the position of the object in the image of the current frame, based on the tracking result information about the object (referred to below as the tracked object) that is tracked in the object tracking process that is performed regarding the chronologically prior frame. In the case where the detection object that is detected in the image of the current frame is associated with the predicted position that is acquired in a prediction process, the tracking unit 508 gives the same identifier as that given to the tracked object regarding the chronologically prior frame to the detection object that is associated with the predicted position. That is, the tracking unit 508 determines that the detection object that is associated with the predicted position among detection objects that are detected in the image of the current frame is the same as the chronologically earlier tracked object when the predicted position is acquired and gives the same identifier. The tracking unit 508 gives a new identifier to a detection object that is not associated with the predicted position among the detection objects that are detected in the image of the current frame. In the case where, among predicted positions that are predicted by the tracking unit 508, a predicted position is not associated with any of the detection objects that are detected in the image of the current frame, the control unit 502 saves the identifier that is associated with the predicted position in the save unit 506.

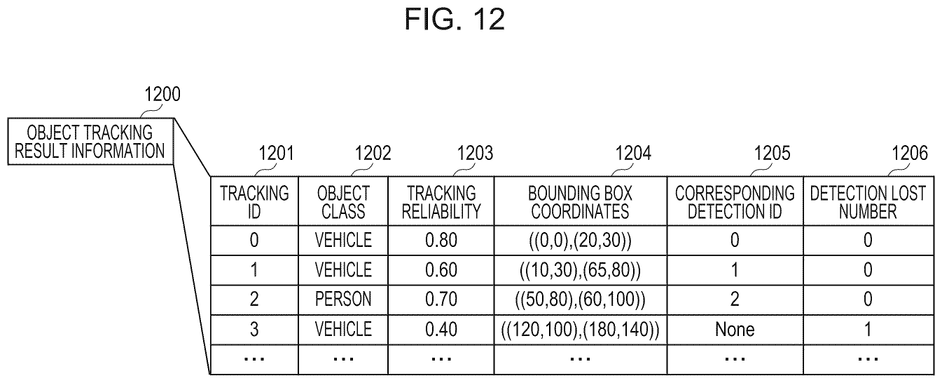

FIG. 12 illustrates an example of the object tracking result information that is acquired in the object tracking process performed by the tracking unit 508. Object tracking result information 1200 includes a tracking ID 1201, an object class 1202, tracking reliability 1203, bounding box coordinates 1204, a corresponding detection ID 1205, and a detection lost number 1206 per tracked object.

The tracking ID 1201 contains an identifier given per tracked object in the past.

In the case where the detection object that is detected in the current frame is the same as the chronologically earlier tracked object, the tracking unit 508 gives the same tracking ID as that given to the chronologically earlier tracked object to the detection object. The tracking ID is a random character string, such as letters or a numeral.

The object class 1202 contains the object class name that represents the type of each tracked object.

The tracking reliability 1203 contains information that represents the reliability of the tracking unit 508 tracking the object. Examples of the information that represents the tracking reliability include a numeral ranging from 0 to 1.

The bounding box coordinates 1204 contain the vertex coordinates of the bounding box that is the tracking rectangle per past tracked object. The bounding box coordinates 1204 have the origin that is at upper left coordinates of the captured image and contain the coordinates (X, Y) of an upper left corner and the coordinates (X, Y) of a lower right corner of the tracking rectangle (the bounding box) as in the bounding box coordinates 1104 in FIG. 11. The bounding box coordinates 1204 contain the coordinates of the tracking rectangle that are slightly corrected based on a positional relationship between the coordinates of the detection rectangle of the detection object that is detected by the detection unit 507 and the coordinates of the predicted position that is predicted by the tracking unit 508.

The corresponding detection ID 1205 contains the detection ID of the detection object that is associated as the same object with the past tracked object, that is, the detection ID of the detection object to which the same tracking ID as that of the tracked object is given. In the case where the detection object is not associated as the same object with the past tracked object, the corresponding detection ID 1205 contains an identifier that represents the absence of the detection object that is associated as the same object with the tracked object, such as “None”.

The detection lost number 1206 contains a numeral that represents the number (the number of frames) of images in which the tracked object and the detection object cannot be associated with each other. That is, the detection lost number 1206 contains a numeral that represents the number (the number of frames) of images in which the same detection object as the tracked object is not present. For example, in the case where the same detection object as the tracked object is not present in the image of the current frame, the detection lost number 1206 contains a value acquired by adding “1” into the stored value. In the case where the same detection object as the tracked object is present in the image of the current frame, the detection lost number 1206 contains a value of “0”.

The description returns to the flowchart in FIG. 10.

Subsequently, at S1004 after S1003 described above, the precision estimation unit 509 performs the precision region estimation process, in which the region in which the detection of the object in the captured image is difficult is estimated, based on the object detection result information, the object tracking result information, and the object presence region information that are saved in the save unit 506. The precision estimation unit 509 generates the precision region image, based on the result of precision region estimation in the precision region estimation process, and transmits the precision region image to the control unit 502. The control unit 502 saves the precision region image in the save unit 506. The precision estimation unit 509 generates, as the result of precision region estimation, the precision region image but may generate not only the precision region image but also, for example, region information that contains precision information values that correspond to the coordinates.

Subsequently, at S1005, the control unit 502 determines whether an instruction on stopping (stopping the program) application or stopping the capturing operation of the image capturing device 110 is inputted from, for example, the user. In the case where the instruction on stopping the application or stopping the image capturing device 110 is not inputted, the control unit 502 returns the processing to S1001 and controls the repetition of the processes at S1001 to S1004 described above. In the case where the instruction on stopping the application or stopping the image capturing device 110 is inputted, the control unit 502 stops a series of the processes at S1001 to S1004 and proceeds the processing to S1006.

After the transition to S1006, the image generation unit 510 performs the image generation process described later.

Processing Flow of Precision Region Estimation according to First Embodiment

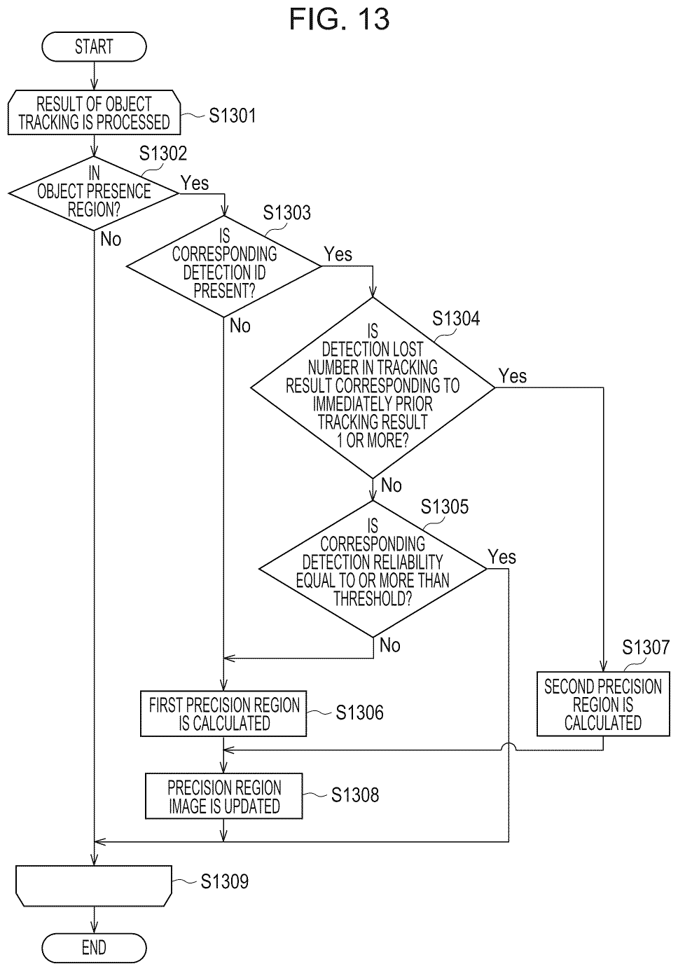

FIG. 13 is a detailed flowchart of the precision region estimation process that is performed by the precision estimation unit 509 at S1004 in FIG. 10.

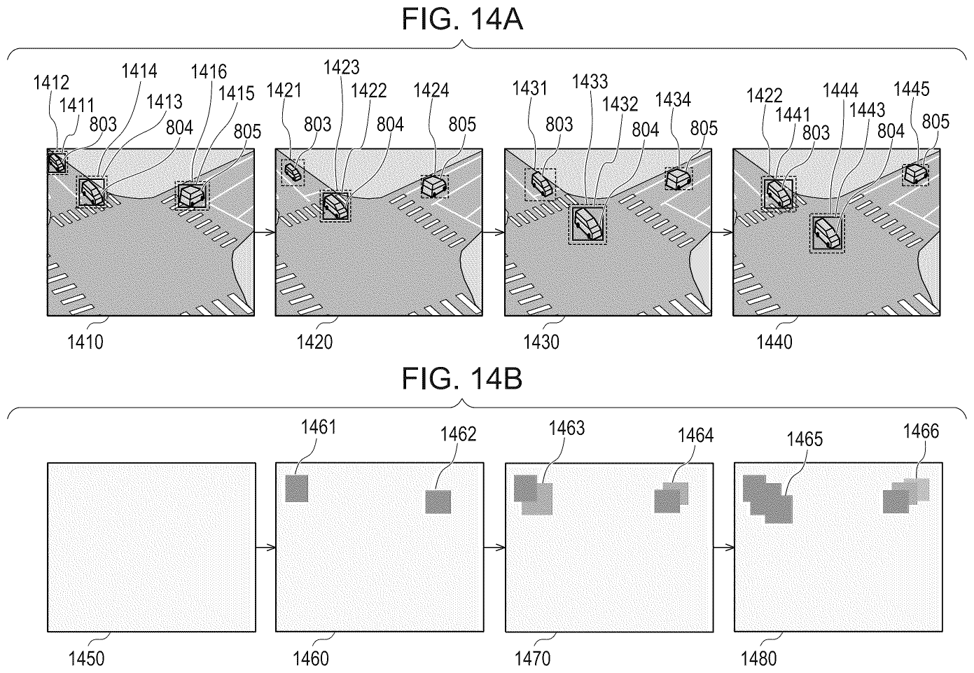

The precision estimation unit 509 sequentially performs loop processes at S1301 to S1309 on the record that corresponds to each tracked object in the object tracking result information 1200 that is saved in the save unit 506. The processes in the flowchart in FIG. 13 are performed by using the object detection result information 1100 and the object tracking result information 1200 that are saved in the save unit 506. For this reason, in the following description, the record that corresponds to each tracked object in the object tracking result information 1200 is referred to as the result of object tracking, and the record that corresponds to each detection object in the object detection result information 1100 is referred to as the result of object detection. The processes at S1302 to S1308 in the flowchart in FIG. 13 will now be described with reference to FIG. 14A and FIG. 14B.

Images 1410, 1420, 1430, and 1440 in FIG. 14A are examples of the captured image and are chronologically acquired from the image capturing device 110 during a certain time. In the images 1410 to 1440, the vehicles 803, 804, and 805 that slowly move appear. In FIG. 14A, the results of the object detection process and the object tracking process that are performed on the vehicles 803 to 805 are illustrated.

As for the image 1410, a detection rectangle 1411 represents the result of object detection for the vehicle 803, and a tracking rectangle 1412 represents the result of object tracking for the vehicle 803. Similarly, a detection rectangle 1413 represents the result of object detection for the vehicle 804, a tracking rectangle 1414 represents the result of object tracking for the vehicle 804, a detection rectangle 1415 represents the circumscribed rectangle of the result of object detection for the vehicle 805, and a tracking rectangle 1416 represents the result of object tracking for the vehicle 805. Also as for the images 1420 to the image 1440, the detection rectangle and the tracking rectangle for each vehicle in the images are illustrated.

In the case of the image 1420, a detection rectangle 1422 represents the result of object detection for the vehicle 804, and a tracking rectangle 1423 represents the result of object tracking for the vehicle 804. In the case of the image 1420, a tracking rectangle 1421 for the vehicle 803 is illustrated, but no detection rectangle is illustrated. That is, in the case of the image 1420, it is represented that the object detection for the vehicle 803 fails. Similarly, a tracking rectangle 1424 for the vehicle 805 is illustrated, but no detection rectangle is illustrated, and accordingly, it is represented that the object detection for the vehicle 805 fails.

In the case of the image 1430, a detection rectangle 1432 represents the result of object detection for the vehicle 804, and a tracking rectangle 1433 represents the result of object tracking for the vehicle 804. In the case of the image 1430, a tracking rectangle 1431 for the vehicle 803 is illustrated, but no detection rectangle is illustrated, and accordingly, it is represented that the object detection for the vehicle 803 fails. Similarly, a tracking rectangle 1434 for the vehicle 805 is illustrated, but no detection rectangle is illustrated, and accordingly, it is represented that the object detection for the vehicle 805 fails.

In the case of the image 1440, a detection rectangle 1441 represents the result of object detection for the vehicle 803, and a tracking rectangle 1442 represents the result of object tracking for the vehicle 803. Similarly, a detection rectangle 1443 represents the result of object detection for the vehicle 804, and a tracking rectangle 1444 represents the result of object tracking for the vehicle 804. In the case of the image 1440, a tracking rectangle 1445 for the vehicle 805 is illustrated, but no detection rectangle is illustrated, and accordingly, it is represented that the object detection for the vehicle 805 fails.

Precision region images 1450, 1460, 1470, and 1480 in FIG. 14B are examples of the precision region image and are generated by the precision estimation unit 509, based on the result of object detection and the result of object tracking for the images 1410 to 1440 illustrated in FIG. 14A.

The precision region image 1450 is rendered based on the estimation accuracy that is calculated in the precision region estimation process in which the result of object detection and the result of object tracking for the image 1410 are used.

In the case of the image 1410, the object can be detected and tracked regarding the vehicles 803 to 805 as described above, the detection of the object in the captured image is not difficult, and accordingly, a precision region that has low estimation accuracy is estimated.

The precision region image 1460 is generated in a manner in which the precision region image 1450 is updated based on the result of object detection and the result of object tracking for the image 1420. In the case of the precision region image 1460, an example in which the regions in which the detection of the object in the captured image is difficult, that is, a precision region 1461 and a precision region 1462 that have high estimation accuracy are estimated is illustrated. The precision region 1461 is estimated based on the result of object detection and the result of object tracking for the vehicle 803, and the precision region 1462 is estimated based on the result of object detection and the result of object tracking for the vehicle 805.

The precision region image 1470 is generated in a manner in which the precision region image 1460 is updated based on the result of object detection and the result of object tracking for the image 1430. In the case of the precision region image 1470, an example in which a precision region 1463 and a precision region 1464 that have high estimation accuracy are estimated as the regions in which the detection of the object is difficult is illustrated. The precision region 1463 is estimated based on the result of object detection and the result of object tracking for the vehicle 803, and the precision region 1464 is estimated based on the result of object detection and the result of object tracking for the vehicle 805. The precision regions 1463 and 1464 are generated in consideration of the precision regions 1461 and 1462 that are estimated by using the precision region image 1460. The precision region 1461 has higher estimation accuracy than that of the precision region 1463 and corresponds to the region in which the detection of the object is difficult. The precision region 1462 has higher estimation accuracy than that of the precision region 1464 and corresponds to the region in which the detection of the object is difficult.

In the illustrated example, the precision region image 1480 is generated in a manner in which the precision region image 1470 is updated based on the result of object detection and the result of object tracking for the image 1440, and a precision region 1465 and a precision region 1466 that have high estimation accuracy are estimated. The precision region 1465 is estimated based on the result of object detection and the result of object tracking for the vehicle 803, and the precision region 1466 is estimated based on the result of object detection and the result of object tracking for the vehicle 805. The precision regions 1465 and 1466 are generated in consideration of the precision regions 1463 and 1464 that are estimated by using the precision region image 1470. The precision region 1464 has higher estimation accuracy than that of the precision region 1466 and corresponds to the region in which the detection of the object is difficult. In the case of the precision region 1465, the precision region 1463 that is estimated by using the precision region image 1470 is updated, and consequently, the precision regions 1461, 1463, and 1465 are illustrated as regions that have the same degree of the estimation accuracy.

The description returns to the flowchart in FIG. 13.

At S1302, the precision estimation unit 509 determines whether the tracking rectangle of the result of object tracking is in the object presence region. According to the present embodiment, the precision estimation unit 509 determines whether the tracking rectangle of the result of object tracking is in the object presence region that corresponds to the applicable object class 1202. More specifically, the precision estimation unit 509 calculates the middle coordinate of the bottom edge of the tracking rectangle of the result of object tracking, based on the vertex coordinates of the bounding box coordinates 1204 that correspond to the result of object tracking. In the case where the applicable object class 1202 and the object class information 902 match each other at the coordinates (X, Y) 901 in the object presence region information 900 that correspond to the middle coordinate, the precision estimation unit 509 determines that the tracking rectangle of the result of object tracking is in the object presence region. Other than this method, the precision estimation unit 509 may calculate the center coordinates of the tracking rectangle of the result of object tracking, for example, based on the vertex coordinates of the bounding box coordinates 1204 that correspond to the result of object tracking and may make the same determination.

For example, the precision estimation unit 509 may calculate the area of the tracking rectangle of the result of object tracking from the bounding box coordinates 1204 and may determine whether the tracking rectangle of the result of object tracking is in the object presence region, based on an area ratio at which the area of the tracking rectangle overlaps the object presence region. For example, in the case where the area ratio at which the area of the tracking rectangle overlaps the object presence region is equal to or more than a predetermined ratio threshold, the precision estimation unit 509 determines that the tracking rectangle of the result of object tracking is in the object presence region.

The precision estimation unit 509 performs a process at S1303 in the case where it is determined that the tracking rectangle of the result of object tracking is in the object presence region as a result of a determination process at S1302 described above and processes the next result of object tracking in the case where it is determined that the tracking rectangle of the result of object tracking is out of the object presence region.

After the transition to S1303, the precision estimation unit 509 determines whether the corresponding detection ID 1205 is present regarding the result of object tracking. For example, the precision estimation unit 509 determines whether information about the corresponding detection ID 1205 is information (for example, “None”) that represents that the result of object detection that corresponds to the result of object tracking is not present. The precision estimation unit 509 performs a process at S1306 in the case where it is determined that the corresponding detection ID 1205 is not present, that is, the corresponding detection ID 1205 is “None” and performs a process at S1304 in the case where it is determined that the corresponding detection ID 1205 is present.

After the transition to S1304, the precision estimation unit 509 determines whether the detection lost number 1206 in the object tracking result information 1200 that corresponds to the immediately prior frame is 1 or more. For example, the precision estimation unit 509 determines whether the detection lost number 1206 that has the same tracking ID as the tracking ID 1201 of the result of object tracking of the current frame and that corresponds to the result of object tracking of the immediately prior frame is a numeral of 1 or more. In the case where it is determined that the detection lost number 1206 is 1 or more, the precision estimation unit 509 performs a process at S1307. In the case where it is determined that the detection lost number 1206 is less than 1, that is, 0, or in the case where the tracking ID 1201 that corresponds to the result of object tracking of the immediately prior frame is not present, the precision estimation unit 509 performs a process at S1305.

After the transition to S1305, the precision estimation unit 509 determines whether the detection reliability 1103 of the result of object detection that corresponds to the result of object tracking is equal to or more than a predetermined reliability threshold. For example, the precision estimation unit 509 determines whether the detection reliability 1103 of the result of object detection of the detection ID 1101 that is represented by the corresponding detection ID 1205 in the object tracking result information 1200 of the result of object tracking of the processing target is equal to or more than the predetermined reliability threshold. The precision estimation unit 509 performs the process at S1302 in which the next result of object tracking is the processing target in the case where it is determined that the detection reliability 1103 is equal to or more than the reliability threshold and performs the process at S1306 in the case where it is determined that the detection reliability 1103 is less than the reliability threshold. In this example, whether the detection reliability 1103 of the result of object detection is equal to or more than the predetermined reliability threshold is determined at S1305. In addition to this, however, the precision estimation unit 509 may determine whether the tracking reliability 1203 of the result of object tracking is equal to or more than the predetermined reliability threshold. For example, in the case where the detection reliability 1103 or the tracking reliability 1203 is less than the predetermined reliability threshold, the precision estimation unit 509 performs the process at S1306.

After the transition to S1306, the precision estimation unit 509 calculates a first precision region. The precision estimation unit 509 calculates the first precision region by generating precision region information based on the estimation accuracy that represents the region in which the detection of the object is difficult regarding the region of the tracking rectangle (the bounding box) of the result of object tracking that is the processing target.

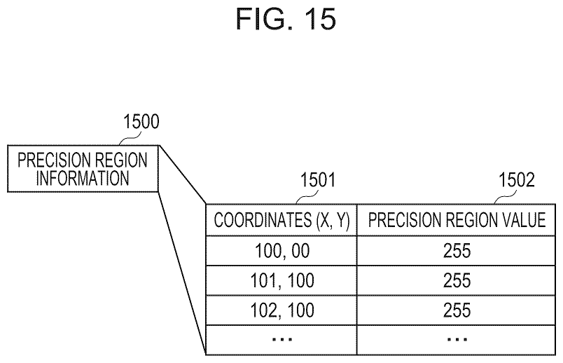

FIG. 15 illustrates an example of precision region information 1500.

The precision region information 1500 includes coordinates (X, Y) 1501 and a precision region value 1502. The coordinates (X, Y) 1501 represent the X and Y coordinates. The coordinates (X, Y) 1501 contain the coordinates (X, Y) of pixel positions that are contained in the tracking rectangle (the bounding box) that is represented by the bounding box coordinates 1204 that correspond to the result of object tracking that is the processing target. The precision region value 1502 contains the numeral of the estimation accuracy that represents the region in which the detection of the object is difficult or the region in which the detection of the object is not difficult. The larger the numeral that is contained in the precision region value 1502, the more difficult the region is to detect. The precision region value 1502 is calculated as an expression (1) described below.

$$Precision Region Value = α \cdot {β}^{n} \qquad Equation ( 1 )$$

In equation (1), a corresponds to the maximum value of a pixel value that is represented by using the precision region image that is defined as a precision score. β is a value that is defined as an attenuation rate and that is no less than 0 and less than 1. n is a value that corresponds to the detection lost number 1206 of the result of object tracking. These values are not limited to the definitions and may be set at other values. After S1306, the precision estimation unit 509 performs a process at S1308.

In the case of the transition to S1307, the precision estimation unit 509 calculates a second precision region. The precision estimation unit 509 performs a second precision region calculation process such that in the case where the tracked object that is tracked by the tracking unit 508, based on the result of object detection performed by the detection unit 507 cannot be tracked, the region of the tracking rectangle that corresponds to the object that cannot be tracked is estimated as the region in which the detection of the object is difficult. The precision estimation unit 509 performs an update process such that the region of the tracking rectangle that corresponds to the object that is tracked by the tracking unit 508 before the tracking unit 508 cannot track the tracked object is estimated also as the region in which the detection of the object is difficult. Specifically, the precision estimation unit 509 generates the precision region information that is updated such that the region that is defined with the same tracking ID 1201 as the object that is the processing target in the past result of object tracking before the detection lost number 1206 becomes 1 is the region in which the detection of the object is difficult. That is, the precision estimation unit 509 updates the precision region value 1502 that is calculated regarding the region in the past result of object tracking before the detection lost number 1206 becomes 1. At this time, the precision region value 1502 is calculated according to equation (2), which is described later. The coordinates (X, Y) 1501 at S1308, which are described later, contain the values of the bounding box coordinates 1204 of the result of object tracking before the detection lost number 1206 of the tracked object that has the same tracking ID 1201 and that is chronologically prior to the result of object tracking of the processing target becomes 1. After S1307, the precision estimation unit 509 performs the process at S1308.

$$Precision Region Value = α \qquad Equation ( 2 )$$

After the transition to S1308, the precision estimation unit 509 updates the precision region image that is saved in the save unit 506 and that corresponds to the object class of the result of object tracking of the processing target, based on the precision region information that is generated in the processes at S1306 and S1307. For example, the precision estimation unit 509 compares the pixel value of the precision region image that corresponds to the coordinates (X, Y) 1501 in the precision region information 1500 and the precision region value 1502 and updates the pixel value of the precision region image that corresponds to the coordinates (X, Y) 1501 by using a larger value. Subsequently, the precision estimation unit 509 processes the next result of tracking.

### Processing Flow of Image Generation

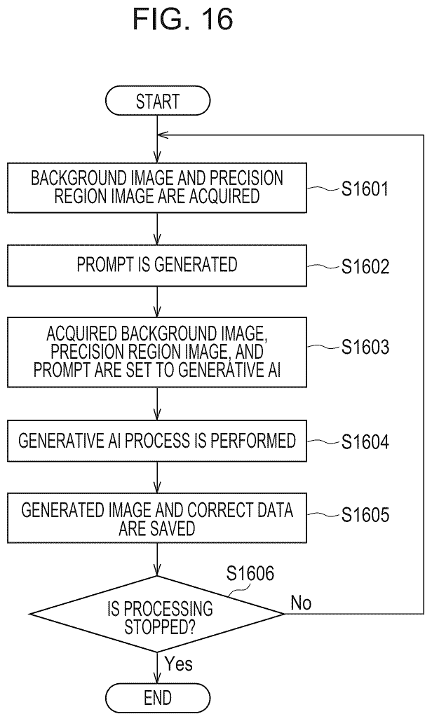

FIG. 16 is a flowchart illustrating the detail of the image generation process that is performed by the image generation unit 510 at S1006 in FIG. 10. The flowchart in FIG. 16 includes a process that is performed by the control unit 502.

At S1601, the image generation unit 510 acquires the background image and the precision region image per object class of the target detection object from the save unit 506. The precision region image may be the image as described above or the region information that contains the precision information values that correspond to the coordinates.

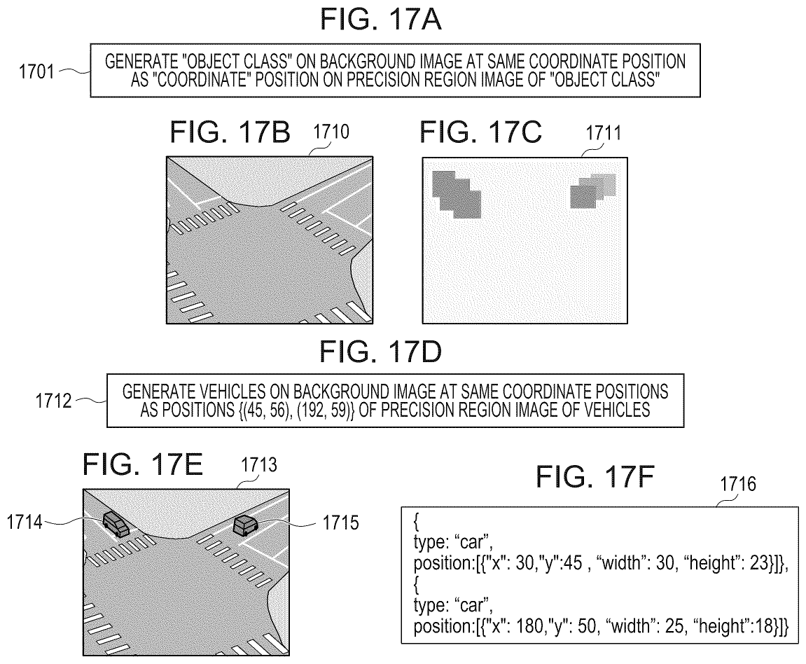

Subsequently, at S1602, the image generation unit 510 generates the prompt. FIG. 17A is a diagram for describing the structure of a prompt 1701 that is generated by the image generation unit 510.

According to the present embodiment, the object class of the precision region image is inputted into the “object class” that is represented by the prompt 1701. Sets of the image coordinates (X, Y) of a region in the precision region image that corresponds to the object class that is inputted as the “object class” are inputted into the “coordinates” that are represented by the prompt. The “coordinates” that are represented by the prompt are calculated such that whether a random object is generated per precision region that changes depending on the estimation accuracy in the precision region image is determined. For example, as for a region in which the object is to be generated, the coordinates (X, Y) of the region are randomly selected, and the selected coordinates are inputted into the “coordinates” that are represented by the prompt 1701.

Subsequently, at S1603, the image generation unit 510 inputs the background image and the precision region image that are acquired at S1601 and the prompt that is generated per object class at S1602 into a generative AI.

At S1604, the image generation unit 510 performs the image generation process based on a generative AI process by using the inputted background image, precision region image, and prompt, and the image generation unit 510 generates the generation image and the correct data.

FIG. 17B to FIG. 17F illustrate input data into the generative AI of the image generation unit 510 and output data from the generative AI, that is, the generation image and the correct data that are generated by the generative AI. FIG. 17B illustrates a background image 1710. FIG. 17C illustrates a precision region image 1711. FIG. 17D illustrates a prompt 1712. FIG. 17E illustrates a generation image 1713. FIG. 17F illustrates correct data 1716.

As for the precision region image 1711 illustrated in FIG. 17C, four types of precision regions are rendered.

The prompt 1712 illustrated in FIG. 17D is generated such that the “object class” is a vehicle, and objects are generated at coordinate positions of two points, based on the precision region image of the vehicles.

The generation image 1713 illustrated in FIG. 17E is generated based on the background image 1710, the precision region image 1711, and the prompt 1712. In the generation image 1713 in FIG. 17E, images of vehicles 1714 and 1715 are generated and disposed in the precision region of the precision region image 1711 and are superimposed on the background image 1710.

The correct data 1716 illustrated in FIG. 17F is data in the JSON format that represents the bounding box that includes information about the vehicle 1714 and the vehicle 1715 regarding the generation image 1713. As for the correct data 1716, a “type” represents the object class, and “position” represents a size and a coordinate position on the image of a rectangle (a bounding box) that surrounds the object per object class. In addition, “x” and “y” represent the vertex coordinate position of the upper left corner of the rectangle in the image, and “width” and “height” represent the width and height of the rectangle in the image. The correct data 1716 is naturally illustrated in FIG. 17F by way of example and is not limited to this example according to the present embodiment.

Subsequently, at S1605, the image generation unit 510 transmits the generation image and the correct data to the control unit 502, and the control unit 502 saves the generation image and the correct data in the save unit 506.

Subsequently, at S1606, the control unit 502 stops and ends processing in the flowchart in FIG. 16 in the case where the user, for example, stops the application and returns the processing of the image generation unit 510 to S1601 in the other cases.

### Precision Region Check·Setting Screen

FIG. 18A and FIG. 18B illustrate examples of the precision region check screen and the precision region setting screen that are generated by the setting unit 505 of the server 130 according to the present embodiment and that are displayed. In practice, the precision region check screen and the precision region setting screen are displayed by the display unit 503, but a description about the displaying by the display unit 503 is omitted to make the description simple.

FIG. 18A illustrates an example of the structure of a precision region check screen 1800. According to the present embodiment, the user can check the precision region of a selected object by watching the precision region check screen 1800 that is displayed.

The precision region check screen 1800 includes an object class name input form 1801, a captured image display region 1802, a precision image display region 1803, an estimation accuracy bar 1804, a setting button 1805, and an end button 1806.

The object class name input form 1801 is a region into which the user inputs the class name of a selected object.

In the captured image display region 1802, the captured image that is acquired from the image capturing device 110 is displayed.

In the precision image display region 1803, the precision region image that corresponds to the object class name that is inputted into the object class name input form 1801 by the user is displayed. After the user inputs a selected object class name into the object class name input form 1801, the setting unit 505 acquires the precision region image that corresponds to the inputted object class name from the save unit 506 and displays the precision region image in the precision image display region 1803. In the precision image display region 1803, the precision region image that is generated by superimposing the object presence region that corresponds to the object class that is inputted by the user may be displayed.

The estimation accuracy bar 1804 represents the degree of the estimation accuracy that is displayed in the precision image display region 1803, and as the degree is represented at a higher position, the estimation accuracy increases.

The setting button 1805 is pushed when the user wants to display the precision region setting screen. After the user pushes the setting button 1805, the setting unit 505 causes a precision region setting screen 1810 illustrated in, for example, FIG. 18B to be displayed.

The end button 1806 is pushed when the user wants to close the precision region check screen 1800. After the user pushes the end button 1806, the setting unit 505 closes the precision region check screen 1800 that is displayed.

FIG. 18B illustrates the structure of the precision region setting screen 1810 that is displayed after the user pushes the setting button 1805 on the precision region check screen 1800 in FIG. 18A. The user can set or reset a new precision region regarding the precision region of a selected object by operating the precision region setting screen 1810 in FIG. 18B.

The precision region setting screen 1810 includes the object class name input form 1801, the captured image display region 1802, the precision image display region 1803, the estimation accuracy bar 1804, a slider 1813, a setting reflection button 1814, and a setting end button 1815. The object class name input form 1801, the captured image display region 1802, the precision image display region 1803, and the estimation accuracy bar 1804 are the same as those in FIG. 18A.

In the case of the precision region setting screen 1810 in FIG. 18B, the user can set, on the captured image, a rectangle (referred to as a precision region setting rectangle) that represents the region in which the detection of the object is difficult while watching the captured image that is displayed in the captured image display region 1802. In an example in FIG. 18B, a precision region setting rectangle 1811 is displayed as the rectangle of the region in which the detection of the object is difficult that is set by the user. For example, after the user inputs a rectangular region on the captured image through an input operation by using the mouse or the keyboard, the setting unit 505 causes the precision region setting rectangle 1811 that corresponds to the rectangular region that is inputted by the user to be displayed in the captured image display region 1802. After the precision region setting rectangle 1811 is set in the captured image display region 1802, the setting unit 505 causes a precision region setting rectangle 1812 to be displayed in the precision image display region 1803 at the coordinate position that corresponds to the precision region setting rectangle 1811 in the precision image display region 1803.

In the case of the precision region setting screen 1810, the setting unit 505 causes the slider 1813 that can slide in response to the input operation from the user on the estimation accuracy bar 1804 to be displayed.

The user can slide the slider 1813 to a selected position on the estimation accuracy bar 1804. The setting unit 505 reflects the same estimation accuracy on the precision region that is represented by the precision region setting rectangle 1812 such that the estimation accuracy matches the estimation accuracy that is represented by the position of the slider 1813 on the estimation accuracy bar 1804. That is, the user sets the precision region setting rectangle 1811 in the captured image display region 1802 and sets the estimation accuracy by operating the slider 1813 and can consequently set the estimation accuracy of the precision region that is represented by the precision region setting rectangle 1812.

The setting reflection button 1814 is pushed on the precision region setting screen 1810 when the user wants to reflect, on the precision region image, the precision region setting rectangle 1812 that represents the precision region for which the estimation accuracy is set. After the user pushes the setting reflection button 1814, the setting unit 505 reflects the precision region setting rectangle 1812 on the precision region image. The control unit 502 saves the precision region image on which the precision region setting rectangle 1812 is reflected in the save unit 506 and consequently updates the precision region image.

In the case where the user wants to end setting on the precision region setting screen 1810, the setting end button 1815 is pushed. After the setting end button 1815 is pushed, the control unit 502 closes the precision region setting screen 1810. After the precision region setting screen 1810 is closed, the precision region check screen 1800 may be displayed again, or the setting on the precision region check screen and the precision region setting screen with the setting unit 505 may end.

According to a first embodiment, learning data that includes the image in which the detection of the object is difficult for the object detector of the detection unit 507 can be easily generated based on the object detection result information from the detection unit 507 and the object tracking result information from the tracking unit 508 as described above. That is, the server 130 according to the present embodiment can automatically generate learning data that includes the generation image in which the object image that depends on the object class is disposed and the correct data in the region that is estimated such that the detection is difficult per object class of the target detection object. Accordingly, according to the present embodiment, manual work effort for generating the learning data can be greatly decreased, and the costs of the generation of the learning data can be decreased.

### Second Embodiment

In the example described according to the first embodiment described above, a region in which the detection of the object does not end or a region that has low detection reliability can be estimated as the region in which the detection of the object is difficult, based on the result of object detection and the result of object tracking. In an example described according to a second embodiment, a region that is mistakenly detected as a region in which an object is present even when no target detection object is present in the region is estimated as a region in which detection is difficult, that is a region in which correct detection is difficult. According to the second embodiment, a system configuration, a device configuration, and a functional configuration are the same as those according to the first embodiment, and accordingly, an illustration and description for these are omitted. Differences from the first embodiment will be mainly described below. Processing Flow of Precision Region Estimation according to Second Embodiment

FIG. 19 is a detailed flowchart illustrating a precision region estimation process according to the second embodiment. According to the second embodiment, the precision estimation unit 509 performs processing in the flowchart illustrated in FIG. 19, and consequently, the region in which no target detection object is present but an object is mistakenly detected is estimated as the region in which detection is difficult (the region that has high estimation accuracy). The precision estimation unit 509 according to the second embodiment estimates the region in which detection is difficult, based on the object tracking result information and at least the amount of movement of the tracked object, the change amount of the aspect ratio of a rectangle (a bounding box), or the size of the rectangle (the bounding box). The precision estimation unit 509 according to the second embodiment performs the same estimation process as that described according to the first embodiment. However, the estimation process that will be described below depends on the amount of movement of the tracked object, the change amount of the aspect ratio of the rectangle, and the size of the rectangle.

In the case of the flowchart in FIG. 19 according to the second embodiment and in the case where it is determined at S1304 that the detection lost number 1206 is less than 1 or the tracking ID 1201 that corresponds to the immediately prior result of object tracking is not present, the precision estimation unit 509 performs a process at S1901.

After the transition to S1901, the precision estimation unit 509 determines whether the amount of movement of the tracked object is equal to or less than a predetermined movement amount threshold. For example, the precision estimation unit 509 calculates the Euclidean distance between two center coordinates that are calculated from the vertex coordinates of the bounding box coordinates 1204 of two tracked objects that are chronologically continuous and that have the same tracking ID 1201 in the object tracking result information 1200. In addition, the precision estimation unit 509 determines whether the calculated Euclidean distance, that is, the amount of movement of the tracked object, is equal to or less than a predetermined distance threshold. In the case where it is determined as a result of the determination process that the amount of movement is equal to or less than the distance threshold, the precision estimation unit 509 performs a process at S1902. In contrast, in the case where it is determined that the amount of movement is more than the distance threshold, the precision estimation unit 509 performs the process at S1306 and calculates the first precision region described above.

In the case of the transition to S1902, the precision estimation unit 509 determines whether the change amount of the aspect ratios of the tracking rectangles (the bounding boxes) of the two tracked objects that are chronologically continuous and that have the same tracking ID 1201 is equal to or less than a predetermined change amount threshold. For example, the precision estimation unit 509 calculates the aspect ratios of the tracking rectangles from the vertex coordinates of the bounding box coordinates 1204 of the tracking rectangles of the two tracked objects that have the same tracking ID 1201. The precision estimation unit 509 calculates, as the change amount of the aspect ratios, a value acquired by dividing the aspect ratio of the chronologically later tracking rectangle by the aspect ratio of the chronologically prior tracking rectangle. The precision estimation unit 509 determines whether the change amount of the aspect ratios is equal to or less than the predetermined change amount threshold and performs a process at S1903 in the case where it is determined that the change amount of the aspect ratios is equal to or less than the change amount threshold. In the case where it is determined that the change amount of the aspect ratios is more than the change amount threshold, the precision estimation unit 509 performs the process at S1306 and calculates the first precision region described above.

In the case of the transition to S1903, the precision estimation unit 509 determines whether the size of each tracking rectangle (each bounding box) is equal to or less than a predetermined size threshold. For example, the precision estimation unit 509 calculates the area of each tracking rectangle from the vertex coordinates of the bounding box coordinates 1204 that correspond to the tracking rectangle and determines whether the area is equal to or less than a predetermined area threshold. In the case where it is determined that the area is equal to or less than the area threshold, the precision estimation unit 509 performs the process at S1305 and determines whether the detection reliability described above is equal to or more than the reliability threshold. In the case where it is determined that the area is more than the area threshold, the precision estimation unit 509 performs the process at S1306 and calculates the first precision region described above.

According to the second embodiment, the precision region estimation process based on at least the amount of movement over time, the change amount of the aspect ratios of the rectangles (the bounding boxes), or the size of each tracking rectangle is performed regarding the precision region estimation as described above. Consequently, the second embodiment enables a region in which false detection can occur, for example, such that no target detection object is present in the region, but an object is mistakenly detected in the region to be estimated as the region in which the detection of the object is difficult. Thus, according to the second embodiment, variations in the generation of learning data that is difficult for the detection unit 507 can be increased.

### Third Embodiment

In an example described according to a third embodiment, processes that differ from those according to the first embodiment described above are performed as a first precision region calculation process and the second precision region calculation process in the precision region estimation process. As for the first precision region calculation process and the second precision region calculation process according to the third embodiment, the use of statistical information for the calculation of a precision region enables the precision region to be more finely estimated than that according to the first embodiment. According to the third embodiment, the system configuration, the device configuration, and the functional configuration are the same as those according to the first embodiment, and accordingly, an illustration and description for these are omitted. Differences from the first embodiment will be mainly described below. Processing Flow of Precision Region Estimation according to Third Embodiment

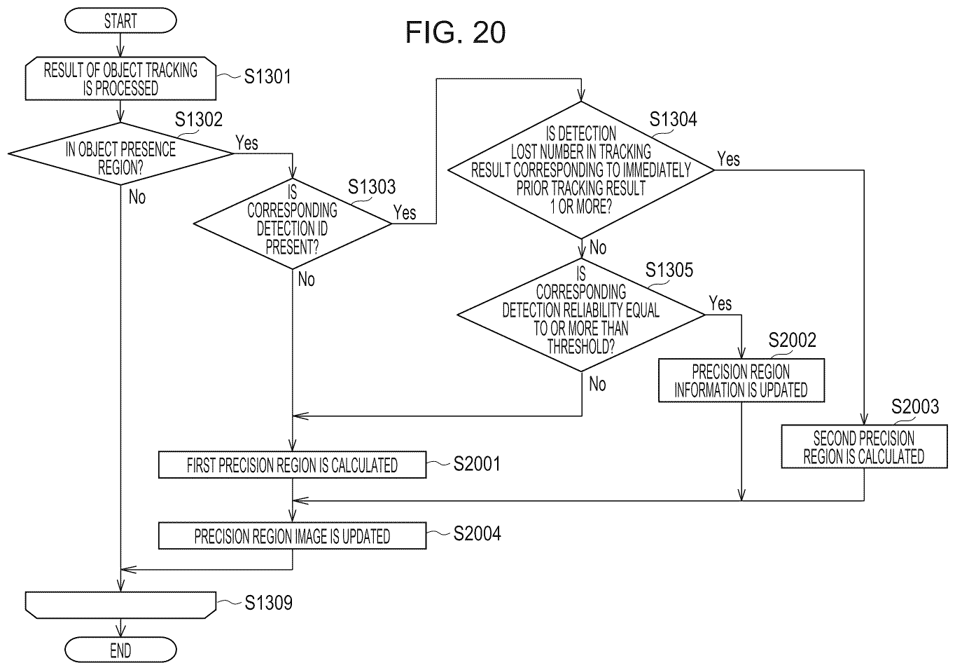

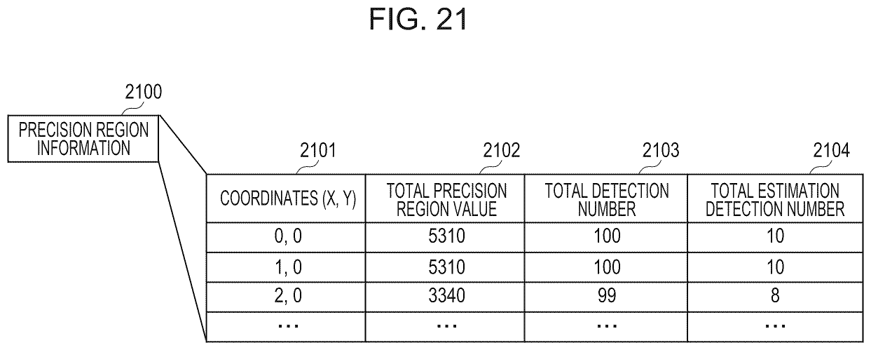

FIG. 20 is a detailed flowchart illustrating the precision region estimation process according to the third embodiment. FIG. 21 illustrates an example of input data for generating the precision region image per object class of the target detection object according to the third embodiment and illustrates the precision region information that is calculated by performing processes at S2001 to S2003 in FIG. 20.

According to the third embodiment, as illustrated in FIG. 21, precision region information 2100 is generated per object class and includes coordinates (X, Y) 2101, a total precision region value 2102, a total detection number 2103, and a total estimation detection number 2104. The coordinates (X, Y) 2101 are sets of the X and Y coordinates and correspond to the coordinates of the pixel positions of the captured image and the precision region image. That is, when the captured image is an image of 1080×720 pixels, the coordinates (X, Y) 2101 contain 1080×720 records. The total precision region value 2102 is the sum of precision region values that are calculated at the corresponding X and Y coordinate positions of the coordinates (X, Y) 2101. The total detection number 2103 is the number of times the object is detected at the corresponding coordinates (X, Y) 2101. The total estimation detection number 2104 is the number of times the region in which the detection of the object is difficult is determined at the corresponding coordinates (X, Y) 2101.

In the case of the flowchart in FIG. 20, and it is determined at S1303 that the corresponding detection ID 1205 is not present, the precision estimation unit 509 performs the first precision region calculation process at S2001 according to the present embodiment. In the case where it is determined at S1305 that the detection reliability 1103 is equal to or more than the reliability threshold, the precision estimation unit 509 performs the first precision region calculation process at S2001. In the case where the detection reliability 1103 is less than the reliability threshold at S1305, the precision estimation unit 509 performs a precision region information update process at S2002 described later. In the case where it is determined that the detection lost number 1206 is 1 or more at S1304, the precision estimation unit 509 performs the second precision region calculation process at S2003 according to the present embodiment.

After the processes at S2001, S2002, and S2003, the precision estimation unit 509 performs a precision region image update process at S2004 described later.

In the case of the transition to S2001, the precision estimation unit 509 performs the first precision region calculation process according to the third embodiment. The precision estimation unit 509 performs the first precision region calculation process according to the third embodiment by calculating the precision region value of the region that corresponds to the bounding box coordinates 1204 of the result of object tracking of the processing target. The precision estimation unit 509 updates the precision region information 2100 by using the calculated precision region value. Specifically, the precision estimation unit 509 performs the precision region information update process by updating the record at the coordinates (X, Y) 2101 that correspond to the coordinates X and Y of the bounding box coordinates 1204 of the result of object tracking in the precision region information 2100. In the case of S2001, the precision estimation unit 509 adds a value calculated as a result of calculation of an equation (3) described below into the total precision region value 2102 and adds 1 into the values of the total detection number 2103 and the total estimation detection number 2104 for update.

$$Precision Region Value = α \cdot {β}^{n} \qquad Equation ( 3 )$$

In the case of the transition to S2002, the precision estimation unit 509 updates the precision region information. For example, the precision estimation unit 509 performs the precision region information update process by updating the record at the coordinates (X, Y) 2101 that correspond to the coordinates X and Y of the bounding box coordinates 1204 of the result of object tracking of the processing target in the precision region information 2100. In the case of S2002, the precision estimation unit 509 adds 1 into the total detection number 2103 for update.

In the case of the transition to S2003, the precision estimation unit 509 performs the second precision region calculation process according to the third embodiment. The precision estimation unit 509 performs the second precision region calculation process by updating the precision region information 2100 so as to target the region in the past result of object tracking that is associated with the same tracking ID 1201 as the result of object tracking of the processing target before the detection lost number 1206 of the tracked object becomes 1. That is, the precision estimation unit 509 updates the record at the coordinates (X, Y) 2101 that correspond to the coordinates X and Y of the bounding box coordinates 1204 of the result of object tracking on which a series of processing is performed such that the total precision region value 2102 that is calculated by using the past precision region value is updated. The precision region value at S2003 is calculated as equation (4) described below. The precision estimation unit 509 adds the value calculated as equation (4) into the total precision region value 2102 for update.

$$Precision Region Value = α ( 1 - {β}^{n} ) \qquad Equation ( 4 )$$

After the transition to S2004 after the process at S2001, S2002, or S2003 described above, the precision estimation unit 509 updates the pixel value of the precision region image that is saved in the save unit 506, based on the precision region information 2100. The precision estimation unit 509 updates the pixel value at the X and Y coordinates of the precision region image that correspond to the coordinates (X, Y) 2101 in the precision region information 2100 by using an equation (5), the total precision region value 2102, the total detection number 2103, and the total estimation detection number 2104 at the coordinates (X, Y) 2101. A pixel (X, Y) in the expression (5) represents the pixel value at the X and Y coordinate positions in the precision region image.

$$Pixel ( X , Y ) = Total Precision Region Value \cdot ( ( Total Estimation Detection Number ) / ( Total Detection Number ) ) \qquad Equation ( 5 )$$

According to the third embodiment, the precision region is calculated by using statistical information such as the total precision region value 2102, the total detection number 2103, and the total estimation detection number 2104 regarding the precision region estimation as described above. Consequently, the third embodiment enables a statistically important region in which the detection of the object is difficult to be estimated based on detection frequency.

### Fourth Embodiment

A method of estimating the precision region according to the first to third embodiments is based on a rule under which the result of object detection and the result of object tracking are used. According to a fourth embodiment, an image generation model that is used for the precision region estimation will be described. According to the fourth embodiment, the system configuration, the device configuration, and the functional configuration are the same as those according to the first to third embodiments, and accordingly, an illustration and description for these are omitted. Differences from the first to third embodiments described above will be described below.

According to the fourth embodiment, the precision estimation unit 509 receives, as input data, the object detection result information, the object tracking result information, the object presence region information, and the prompt described later; performs the image generation process; and generates the precision region image. The image generator that is used by the precision estimation unit 509 according to the present embodiment for the image generation process uses the image generation model that was trained by machine learning where a lurking pattern is found from a large amount of data by repeatedly making calculations in the same manner as described above. An example of the image generation model can be the technique disclosed in the reference described above.

According to the fourth embodiment, the save unit 506 also saves the image generation model that is used by the image generator of the precision estimation unit 509 in addition to the same information as that saved in the save unit 506 according to the embodiments described above.

Flow of Image Generation Process in which Precision Region Image is Generated

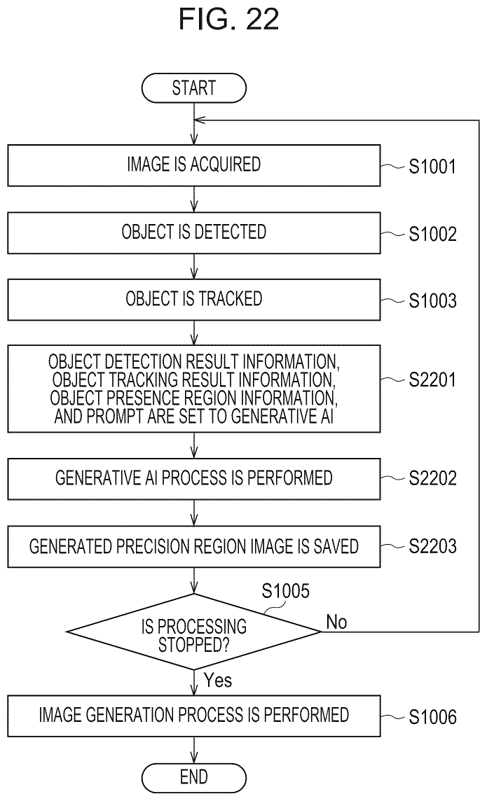

FIG. 22 is a flowchart illustrating the entire flow of information processing that is performed by the functional units of the server 130 according to the fourth embodiment. In the flowchart in FIG. 22, processes at S1001 to S1003, S1005, and S1006 are substantially the same as the processes in FIG. 10 described above, and accordingly, a description for these is omitted. In the case of the flowchart in FIG. 22, the precision estimation unit 509 performs processes at S2201 to S2203 after the process at S1003, and subsequently, the server 130 performs the process at S1005.

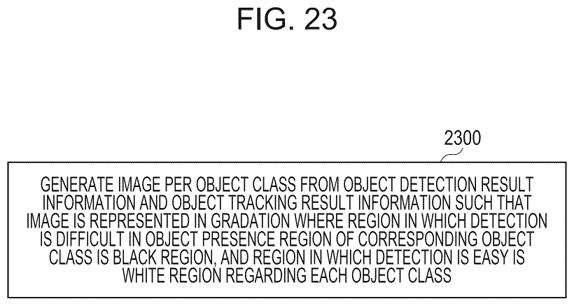

After the transition to S2201, the precision estimation unit 509 inputs (sets) the object detection result information, the object tracking result information, the object presence region information, and the prompt described later that are saved in the save unit 506 into the generative AI for generating the precision region image. FIG. 23 illustrates an example of a prompt 2300 that is inputted into the generative AI for generating the precision region image at S2201.

Subsequently, at S2202, the precision estimation unit 509 receives the object detection result information, the object tracking result information, the object presence region information, and the prompt, and the precision estimation unit 509 performs the image generation process by using the generative AI and generates the precision region image and the correct data.

Subsequently, at S2203, the precision estimation unit 509 saves the precision region image and the correct data that are generated at S2202 in the save unit 506 via the control unit 502.

According to the fourth embodiment, the precision estimation unit 509 can generate the precision region image by using the image generation model as described above.

### Fifth Embodiment

According to the first to third embodiments, different methods of estimating the precision region are described. In an example described according to a fifth embodiment, a detailed parameter that is used for the image generation in which the image generation model is used is estimated in addition to the estimation of the precision region. According to the fifth embodiment, the system configuration, the device configuration, and the functional configuration are the same as those according to the first to third embodiments, and accordingly, an illustration and description for these are omitted. Differences from the first to third embodiments will be described below.

Processing Flow according to Fifth Embodiment

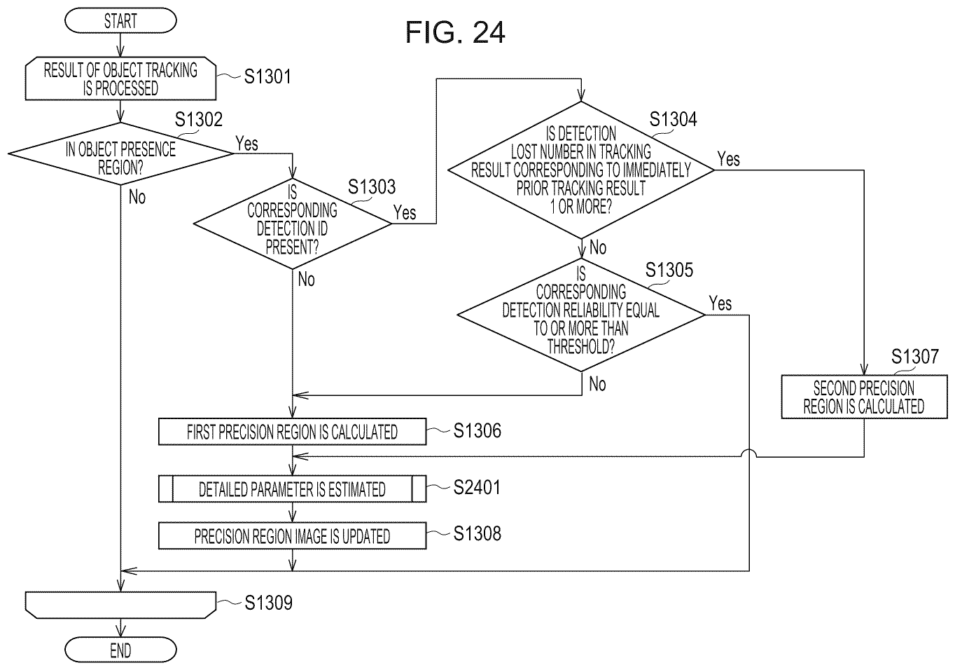

FIG. 24 is a detailed flowchart illustrating the precision region estimation process that is performed by the precision estimation unit 509 according to the fifth embodiment. In the case of the flowchart in FIG. 24, the precision estimation unit 509 performs a process at S2401 after the processes at S1306 and S1307 and performs the process at S1308 after the process at S2401.

After the transition to S2401, the precision estimation unit 509 estimates the detailed parameter that is used in the image generation process of the image generation unit 510 regarding the region (the region that has high estimation accuracy) in which the detection of the object is difficult that is estimated at S1306 to S1308. According to the present embodiment, examples that are estimated by the precision estimation unit 509 as the detailed parameter that is used in the image generation process of the image generation unit 510 include “weather”, a “time zone”, and “color”. According to the present embodiment, the precision estimation unit 509 estimates the parameters of the “weather”, the “time zone”, and the “color” but is not limited thereto, but only any one of these parameters may be estimated, two parameters may be estimated, or another parameter may be estimated.

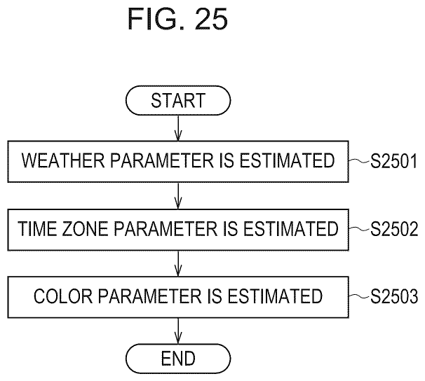

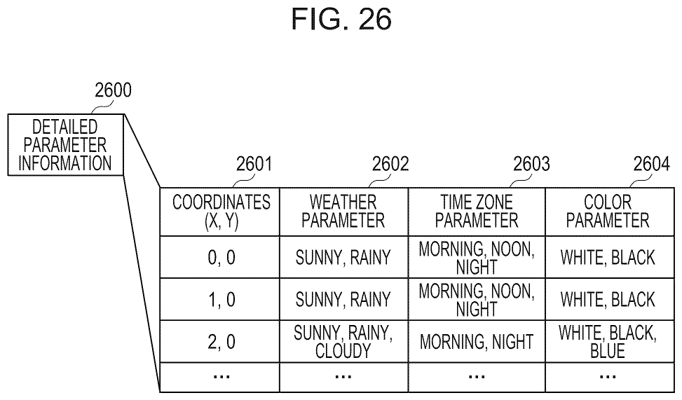

FIG. 25 is a flowchart illustrating a parameter estimation process that is performed at S2401 in FIG. 24. FIG. 26 illustrates an example of detailed parameter information 2600 that contains the parameters that are estimated at S2501 to S2503 in the flowchart in FIG. 25. In FIG. 26, the detailed parameter information 2600 includes coordinates (X, Y) 2601, a weather parameter 2602, a time zone parameter 2603, and a color parameter 2604.

The detailed parameter information 2600 that is estimated and acquired by the precision estimation unit 509 is saved in the save unit 506.

At S2501, the precision estimation unit 509 first estimates the weather parameter. For example, the precision estimation unit 509 estimates the weather parameter by using a model that has learned, by using machine learning, such that the weather is estimated from the image. For example, the precision estimation unit 509 receives the target image for the precision region estimation process described above, performs the parameter estimation process by using the model that has learned, and acquires, as the result of estimation of the parameter, text data that represents the weather. The precision estimation unit 509 adds the text data of the weather into the weather parameter 2602 in the detailed parameter information 2600 at the coordinates (X, Y) 2601 that correspond to the region that is estimated such that the detection of the object is difficult in the precision region estimation process at S1306 to S1308.

Subsequently, at S2502, the precision estimation unit 509 estimates the time zone parameter. The precision estimation unit 509 assigns the target image for estimation of the precision region to a time zone that is defined in advance, for example, based on a timestamp that is added into the captured image when the captured image is captured by the image capturing device 110. For example, in the case where the time zone is defined such that a zone of 6 o'clock to 10 o'clock corresponds to “morning”, a zone of 10 o'clock to 16 o'clock corresponds to “noon”, a zone of 16 o'clock to 18 o'clock corresponds to “evening”, and a zone of 18 o'clock to 6 o'clock corresponds to “night”, the precision estimation unit 509 acquires the text data of the time zone that corresponds to the timestamp of the captured image. The precision estimation unit 509 adds the text data of the time zone into the time zone parameter 2603 in the detailed parameter information 2600 at the coordinates (X, Y) 2601 that correspond to the region that is estimated such that the detection of the object is difficult in the precision region estimation process at S1306 to S1308.

Subsequently, at S2503, the precision estimation unit 509 estimates the color parameter. For example, the precision estimation unit 509 estimates the color parameter from an image of a bounding box rectangle that is estimated as the region in which the detection of the object is difficult at S1306 to S1307 and that is cut from the target image for estimation of the precision region. According to the present embodiment, the precision estimation unit 509 assigns the cut image to a color that is defined in advance, based on a statistic in the color information about the cut image. For example, the precision estimation unit 509 converts the cut image of the bounding box rectangle into an HSV image that represents hue, saturation, or brightness, and the precision estimation unit 509 calculates, as the statistic of the cut image, the mode of H, S, and V of pixels in the cut image. According to the present embodiment, text data of color that corresponds to the H, S, and V values of the pixels is defined in advance, and the precision estimation unit 509 acquires the text data of the color, based on the value that is calculated as the statistic as described above. The statistic may be an average value or a median other than the example described above.

The precision estimation unit 509 adds the text data of the color into the color parameter 2604 in the detailed parameter information 2600 at the coordinates (X, Y) 2601 that correspond to the region that is estimated such that the detection of the object is difficult at S1306 to S1307.

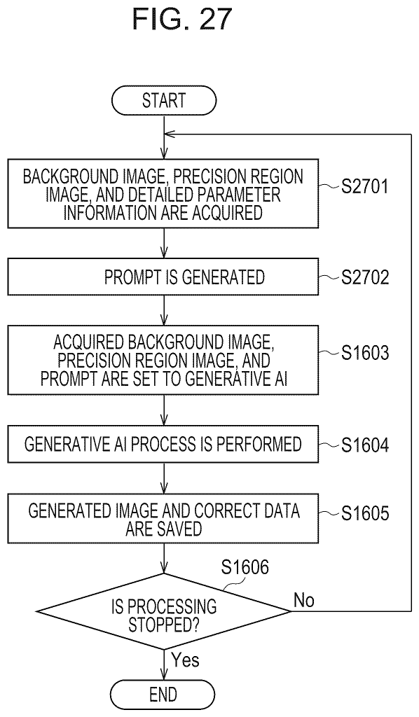

FIG. 27 is a flowchart illustrating the image generation process according to the fifth embodiment that is performed by the image generation unit 510 by using the parameter that is estimated by the precision estimation unit 509 as described above. In the flowchart in FIG. 27, processes at S1603 to S1606 are the same as those in the flowchart in FIG. 16 described above. In the case of the flowchart in FIG. 27, the image generation unit 510 performs the process at S1603 after the processes at S2701 and S2702 are performed.

At S2701, the image generation unit 510 first acquires the background image, the precision region image, and the detailed parameter information that are saved in the save unit 506.

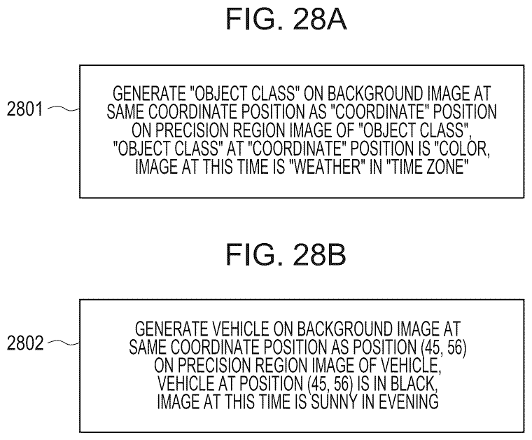

Subsequently, at S2702, the image generation unit 510 generates the prompt described later. A prompt 2801 in FIG. 28A and a prompt 2802 in FIG. 28B are examples of the prompt that is generated by the image generation unit 510.

The object class of the precision region image that is acquired from the save unit 506 is inputted into “object class” that is represented by the prompt 2801 in FIG. 28A. A set of the coordinates (X, Y) of the precision region image that corresponds to the object class that is inputted into the “object class” are inputted into “coordinates” that are represented by the prompt 2801. The “coordinates” that are represented by the prompt 2801 are calculated depending on the result of a determination whether a random object is generated per precision region that changes depending on the estimation accuracy in the precision region image. For example, as for the region in which the object is generated, the coordinates (X, Y) are randomly selected in the region, and the selected coordinates are inputted into the “coordinates” that are represented by the prompt 2801. A value that is randomly selected from the color parameter in the detailed parameter information at a randomly selected coordinate position is inputted into the “color” that is represented by the prompt 2801. Values that are selected from the detailed parameter information at the randomly selected coordinate position so as to entirely cover the corresponding weather parameter and time zone parameter are inputted into the “weather” and the “time zone” that are represented by the prompt 2801. That is, in the case where the weather parameter and the “time zone parameter” have multiple values at the randomly selected coordinate position, the prompt is generated such that all of the patterns are covered.

The prompt 2802 in FIG. 28B is generated such that the “object class” is a vehicle; the object is generated at the coordinate position of a single point, based on the precision region image of the vehicle; the “color” is black; the “weather” is sunny; and the “time zone” is evening, based on the detailed parameter information at the coordinate position.

According to the fifth embodiment, the precision estimation unit 509 estimates the detailed parameter, such as the weather, the time zone, or the color information about the object, when the region in which the detection of the object is difficult is estimated as described above. According to the fifth embodiment, the image generation unit 510 performs the image generation process by using the detailed parameter, and consequently, the learning data that is difficult for the object detector of the detection unit 507 can be effectively generated.

The present disclosure can also be carried out in a manner in which the system or the apparatus is provided with a program that fulfills one or more functions according to the embodiments described above via a network or a storage medium and one or more processors of a computer of the system or the apparatus read and execute the program. The present disclosure can also be carried out by a circuit (for example, an ASIC) that fulfills one or more functions. The embodiments are just specific examples for carrying out the present disclosure, and the technical range of the present disclosure is not restrictively interpreted due to these.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-051852, which was filed on Mar. 27, 2024 and which is hereby incorporated by reference herein in its entirety.

What is claimed is:

1. An information processing apparatus comprising:
at least one memory storing instructions; and
at least one processor that, upon execution of the stored instructions, causes the information processing apparatus to:
detect an object in a captured image;
track the object in a chronologically captured image, based on a result of the detection of the object;
estimate, from the captured image, a region in which detection of the object in the captured image is difficult for the detection unit per type of the object, based on the result of the detection of the object and a result of the tracking of the object; and
generate an image acquired by superimposing, on a predetermined background image, a predetermined object image that corresponds to the type of the object, based on a result of the estimation.

2. The information processing apparatus according to claim 1,
wherein the at least one processor, upon execution of the stored instructions, further causes the information processing apparatus to estimate the region from a region in the captured image that is defined such that the object is present.

3. The information processing apparatus according to claim 1,
wherein the at least one processor, upon execution of the stored instructions, further causes the information processing apparatus to acquire an estimation accuracy of the region in which the detection of the object is difficult per type of the object and determine the region in which the detection of the object is difficult, based on the estimation accuracy.

4. The information processing apparatus according to claim 3,
wherein the at least one processor, upon execution of the stored instructions, further causes the information processing apparatus to adjust an estimation accuracy of a second region to an estimation accuracy higher than that of a first region that corresponds to the object in the captured image that is detected, based on the result of detection of the object and the result of tracking of the object, the second region being a region in which the object is not detected and corresponding to the object that is tracked.

5. The information processing apparatus according to claim 4,
wherein the at least one processor, upon execution of the stored instructions, further causes the information processing apparatus to adjust an estimation accuracy of a third region to be higher than that of the second region, the third region being a region in which the object is not detected and the object is not tracked.

6. The information processing apparatus according to claim 3,
wherein the at least one processor, upon execution of the stored instructions, further causes the information processing apparatus to generate the image acquired by superimposing, on the predetermined background image, the predetermined object image preferentially in a region the estimation accuracy of which is high.

7. The information processing apparatus according to claim 1,
wherein the at least one processor, upon execution of the stored instructions, further causes the information processing apparatus to estimate the region in which the detection of the object is difficult, based on at least reliability of the detection or reliability of the tracking.

8. The information processing apparatus according to claim 7,
wherein the at least one processor, upon execution of the stored instructions, further causes the information processing apparatus to estimate, as the region in which the detection of the object is difficult, a region in which at least the reliability of the detection or the reliability of the tracking is less than a predetermined reliability threshold.

9. The information processing apparatus according to claim 1,
wherein the at least one processor, upon execution of the stored instructions, further causes the information processing apparatus to set, as the region in which the detection of the object is difficult, a region in the captured image that is set by a user.

10. The information processing apparatus according to claim 1,
wherein the at least one processor, upon execution of the stored instructions, further causes the information processing apparatus to estimate the region in which the detection of the object is difficult based on an amount of movement of the object that is tracked.

11. The information processing apparatus according to claim 10,
wherein the at least one processor, upon execution of the stored instructions, further causes the information processing apparatus to estimate, as the region in which the detection of the object is difficult, a region in which the amount of movement of the object is more than a predetermined amount of movement.

12. The information processing apparatus according to claim 1,
wherein the at least one processor, upon execution of the stored instructions, further causes the information processing apparatus to estimate the region in which the detection of the object is difficult, based on a first aspect ratio of a region that corresponds to the object and that is chronologically earlier and a second aspect ratio of a region that corresponds to the object and that is chronologically later.

13. The information processing apparatus according to claim 12,
wherein the at least one processor, upon execution of the stored instructions, further causes the information processing apparatus to estimate the region in which the detection of the object is difficult based on a change amount of the second aspect ratio with respect to the first aspect ratio.

14. The information processing apparatus according to claim 13,
wherein the at least one processor, upon execution of the stored instructions, further causes the information processing apparatus to calculate, as the change amount, a value acquired by dividing the first aspect ratio by the second aspect ratio and estimate, as the region in which the detection of the object is difficult, a region in which the change amount is more than a predetermined change amount threshold.

15. The information processing apparatus according to claim 1,
wherein the at least one processor, upon execution of the stored instructions, further causes the information processing apparatus to estimate the region in which the detection of the object is difficult based on a size of a region that corresponds to the object that is tracked.

16. The information processing apparatus according to claim 15,
wherein the at least one processor, upon execution of the stored instructions, further causes the information processing apparatus to estimate, as the region in which the detection of the object is difficult, a region the size of which is more than a predetermined size threshold.

17. The information processing apparatus according to claim 1,
wherein the at least one processor, upon execution of the stored instructions, further causes the information processing apparatus to, in a case where an object cannot be tracked, based on the result of detection of the object, estimate, as the region in which the detection of the object is difficult, a region that corresponds to the object that cannot be tracked.

18. The information processing apparatus according to claim 17,
wherein the at least one processor, upon execution of the stored instructions, further causes the information processing apparatus to estimate, as the region in which the detection of the object is difficult, a region that corresponds to the object that is tracked before the object cannot be tracked.

19. An information processing method comprising:
a detection step of detecting an object in a captured image;
a tracking step of tracking the object in a chronologically captured image, based on a result of detection of the object at the detection step;
an estimation step of estimating, from the captured image, a region in which detection of the object in the captured image is difficult at the detection step per type of the object, based on the result of detection of the object at the detection step and a result of tracking of the object at the tracking step; and
a generation step of generating an image acquired by superimposing, on a predetermined background image, a predetermined object image that corresponds to the type of the object, based on a result of estimation at the estimation step.

20. A non-transitory computer-readable medium storing computer-executable instructions for causing a computer to execute a method comprising:
a detection step of detecting an object in a captured image;
a tracking step of tracking the object in a chronologically captured image, based on a result of detection of the object at the detection step;
an estimation step of estimating, from the captured image, a region in which detection of the object in the captured image is difficult at the detection step per type of the object, based on the result of detection of the object at the detection step and a result of tracking of the object at the tracking step; and
a generation step of generating an image acquired by superimposing, on a predetermined background image, a predetermined object image that corresponds to the type of the object, based on a result of estimation at the estimation step.
